(19) United States
(12) Patent Application Publication
(10) Pub. No.: US 2017/0048719 A1
(43) Pub. Date: Feb. 16, 2017

(54) TERMINAL DEVICE, PROCESSING METHOD, BASE STATION APPARATUS, AND PROCESSING DEVICE

(71) Applicant: Sharp Kabushiki Kaisha, Sakai City, Osaka (JP)

(72) Inventors: Jungo GOTO, Sakai City (JP); Shiro WAKAHARA, Sakai City (JP); Osamu NAKAMURA, Sakai City (JP); Hiromichi TOMEBA, Sakai City (JP); Yasuhiro HAMAGUCHI, Sakai City (JP)

(21) Appl. No.: 15/305,392

(22) PCT Filed: Apr. 21, 2015
(86) PCT No.: PCT/JP2015/062157

§ 371 Date: Oct. 20, 2016

(30) Foreign Application Priority Data
Apr. 24, 2014 (JP) 2014-089956

(51) Int. Cl. H04W 16/14

(52) U.S. Cl. CPC H04W 16/14

(57) ABSTRACT

When an unlicensed band is used, a more efficient control is provided, and a communication is established, or ensured and continues by stably using the unlicensed band. According to the present invention, there is provided a base station apparatus which applies a communication scheme applied to a frequency band allowed to be dedicatedly used, to a frequency band of which dedicated use is not allowed, and enables a communicate with a terminal device by using the frequency band of which dedicated use is not allowed, along with the frequency band allowed to be dedicatedly used. In a state where the frequency band of which dedicated use is not allowed is not used for a communication with the terminal device, to which the communication scheme is applied, the terminal device is notified of control information, and thus the communication scheme is applied to the frequency band of which dedicated use is not allowed, and the terminal device is instructed to communicate with the base station apparatus. The control information is required for a control when the frequency band of which dedicated use is not allowed is used in a communication with the terminal device, to which the communication scheme is applied.

### TECHNICAL FIELD

The present invention relates to a terminal device, a processing method, a base station apparatus, and a processing device.

### BACKGROUND ART

The progress of a radio access scheme and a radio network of cellular mobile communication (referred to below as “Long Term Evolution (LTE)” or “Evolved Universal Terrestrial Radio Access: EUTRA”) has been examined by the 3rd Generation Partnership Project (3GPP). In LTE, as a communication scheme of wireless communication (downlink) from a base station apparatus (also referred to as an evolved Node B and an eNB) to a terminal device (also referred to as a mobile station apparatus, User Equipment, and UE), an orthogonal frequency division multiplexing (OFDM) scheme, which is a type of multi-carrier transmission, is used. As a communication scheme of wireless communication (uplink) from a terminal device to a base station apparatus, a single-carrier frequency division multiple access (SC-FDMA) scheme, which is a type of single-carrier transmission, is used.

In 3GPP, a radio access scheme and a radio network (referred to below as “long term evolution-advanced (LTE-A)” or “advanced evolved universal terrestrial radio access (A-EUTRA)”) in which data communication at higher speed is realized by using a frequency band that is broader than that of LTE are examined. In LTE-A, the following are obtained: backward compatibility with LTE, that is, an LTE-A base station apparatus performs wireless communication with a terminal device in both LTE-A and LTE simultaneously; and an LTE-A terminal device is defined to perform wireless communication with a base station apparatus in both LTE-A and LTE. LTE-A is examined by using the same channel structure as that in LTE.

In LTE-A, a technology (a frequency band aggregation scheme: also referred to as spectrum aggregation, carrier aggregation, frequency aggregation, and the like) in which frequency bands (referred to below as a “component carrier (CC)”) of the same channel structure as that in LTE are aggregated into a single frequency band (broad frequency band) is examined. Specifically, in communication using a frequency band aggregation scheme of frequency division duplexing (FDD), a downlink channel is transmitted for each downlink component carrier, and an uplink channel is transmitted for each uplink component carrier. That is, the frequency band aggregation scheme is a technology in which a base station apparatus and a plurality of terminal devices simultaneously transmit and receive plural pieces of data or plural pieces of control information by using a plurality of channels or a plurality of component carriers in an uplink and a downlink.

In communication using the frequency band aggregation scheme, there is a technique in which a base station apparatus configures, by using a radio resource control (RRC) signal and the like, downlink component carriers (DLCCs) and uplink component carriers (ULCCs) that are used in communication with a terminal device, and performs notification of an activation command by using a physical downlink control channel (PDCCH), a medium access control (MAC) control element (CE), or the like. The activation command indicates a downlink component carrier used for downlink communication among the configured DLCCs (NPL 1).

### CITATION LIST

### Non Patent Literature

NPL 1: “Open issues on component carrier activation and deactivation”, 3GPP TSG RAN WG2 Meeting #69, R2-101082, Feb. 22-26, 2010.

### SUMMARY OF INVENTION

### Technical Problem

Recently, however, an increase in the quantity of transmission data or the number of subscribers causes communication resources to significantly become insufficient. For example, the number of pieces of image data or video data as data which is transmitted and received by a user is increased, and image quality is improved. Thus, the quantity of data which is to be transmitted and received is significantly increased. Thus, the number of communication resources used by one user is necessarily increased. Focusing on the number of subscribers using LTE or LTE-A, there has recently been a large increase in the number of users who have changed from W-CDMA or GSM (registered trademark) to LTE or LTE-A. As described above, the insufficiency in communication resources due to an increase in the volume of communication data or an increase of the number of users is serious. Thus, recently, the use of unlicensed bands has attracted attention.

A communication carrier (may be also referred to as an operator or a carrier) provides a subscriber with commercial communication by dedicatedly using a frequency band which has been officially permitted. For example, a base station allocates, as a communication resource to a subscriber (terminal), a portion of a frequency band for which dedicated use is allowed. In a case where a plurality of terminals are provided, portions of the frequency band, which are different from each other, are allocated as communication resources to the respective plurality of terminals, and thus simultaneous communication with the plurality of terminals is enabled. A terminal communicates with another terminal via the base station by using the allocated communication resource. The frequency band for which dedicated use is permitted may also be referred to as a frequency band for which dedicated use is allowed or simply as a dedicated communication band or a licensed band. In other words, a frequency band that has been permitted for use and that can be dedicatedly used when a communication carrier enables communication with a plurality of terminals is simply defined as a frequency band that has been allowed to be dedicatedly used, or as a dedicated frequency band or a licensed band. In this specification, the above frequency band is defined as a licensed band in the following descriptions. On the contrary, a frequency band which is not permitted to be dedicatedly used, and of which dedicated use is not allowed, but for which temporary use is allowed, may also be referred to as a frequency band of which dedicated use is not allowed, or simply as a non-dedicated frequency band or an unlicensed band. In this specification, the above frequency band is defined as an unlicensed band below. For example, a frequency band used by a wireless LAN and the like is exemplified as an unlicensed band. Generally, for example, an unlicensed band is used for a connection between a personal computer and a printer, and the like, based on the IEEE 802.11n specification. Wireless LAN standards include standards other than IEEE 802.11n, such as IEEE 802.11a, b, g, and ac.

However, since an unlicensed band is originally a frequency band of which dedicated use is not allowed, various restrictions are applied. In addition, generally, it is not assumed that a general terminal communicates with a base station by using an unlicensed band. One or neither of specific use means and specific control means for the unlicensed band is provided, and thus, using the unlicensed band in communication is not possible in practice. Similarly, it is also difficult to use the unlicensed band in communication of a base station with a terminal.

To solve the above problems, an object of the present invention is to provide more efficient control when an unlicensed band is used and to provide control in which communication can be established, or be ensured, and can continue by stably using the unlicensed band.

### Solution to Problem

(1) To achieve the above object, the present invention includes means as follows. That is, according to the present invention, there is provided a base station apparatus which applies a first communication scheme applied to a first frequency band, which is a frequency band allowed to be dedicatedly used, to a second frequency band which is a frequency band different from the first frequency band, so as to enable communication with a base station apparatus by using the second frequency band along with the first frequency band, which enables a first communication in which the first communication scheme is applied to the second frequency band so as to perform communication with the base station apparatus, and a second communication in which a second communication scheme different from the first communication scheme is applied to the second frequency band so as to enable communication with a device other than the base station apparatus, and which performs the second communication in an activated state which is a state in which the first communication is enabled.

(2) The terminal device receives first information indicating that at least one of the second frequency bands is used, or second information indicating that at least one of the second frequency bands is not used from the base station apparatus.

(3) The first information is information used only in a case of indicating that all of the second frequency bands are used. The second information is information used only in a case of indicating that not all of the second frequency bands are used.

(4) The first information is information indicating a frequency band which is used among a plurality of second frequency bands. The second information is information indicating a frequency band which is used among the plurality of second frequency bands.

(5) The first information is information indicating a frequency band which is used among the plurality of second frequency bands and is information which is previously prepared as information indicating a combination of the second frequency bands. The second information is information which is previously prepared as information indicating the combination.

(6) It is determined, based on third information which is indicated by a base station, whether or not the second communication is possible.

(7) The third information indicated by the base station indicates whether the first frequency band or the second frequency band is used for a notification of information of scheduling, which indicates communication resources when the first communication scheme is applied to the second frequency band so as to perform the first communication.

(8) There is provided a processing method which is a processing method of a terminal device. The processing method includes applying, to a second frequency band which is a frequency band different from the first frequency band, a communication scheme applied to a first frequency band which is a frequency band allowed to be dedicatedly used, and enabling communication with a base station apparatus by using the second frequency band along with the first frequency band. The terminal device allows a first communication in which communication with the base station apparatus is performed by using the communication scheme for the second frequency band, and a second communication in which a communication scheme different from the communication scheme is applied to the second frequency band so as to perform communication with a device other than the base station apparatus. The terminal device performs the second communication in an activated state which is a state in which the first communication is possible.

(9) There is provided a base station apparatus which applies, to a second frequency band which is a frequency band different from the first frequency band, a communication scheme applied to a first frequency band which is a frequency band allowed to be dedicatedly used, which enables communication with a terminal device by using the second frequency band and the first frequency band, and which selectively notifies the terminal device of first information indicating that all of the second frequency bands are used, or second information indicating that not all of the second frequency bands are used.

(10) There is provided a processing method which is a processing method of a base station apparatus. The processing method includes applying a communication scheme applied to a first frequency band which is a frequency band allowed to be dedicatedly used, to a second frequency band which is a frequency band different from the first frequency band, and enabling communication with a terminal device by using the second frequency band along with the first frequency band. The base station apparatus selectively notifies the terminal device of first information indicating that all of the second frequency bands are used, or second information indicating that not all of the second frequency bands are used.

(11) There is provided a processing device mounted in a terminal device which applies a communication scheme applied to a first frequency band which is a frequency band allowed to be dedicatedly used, to a second frequency band which is a frequency band different from the first frequency band, and enables communication with a base station apparatus by using the second frequency band along with the first frequency band. The processing device enables a first communication in which communication with the base station apparatus is performed by using the communication scheme for the second frequency band, and a second communication in which a communication scheme different from the communication scheme is applied to the second frequency band so as to communicate with a device other than the base station apparatus, and causes the second communication to be performed in a terminal device, in an activated state which is a state where the first communication is possible.

(12) There is provided a processing device mounted in a base station apparatus which applies a communication scheme applied to a first frequency band which is a frequency band allowed to be dedicatedly used, to a second frequency band which is a frequency band different from the first frequency band, and enables communication with a terminal device by using the second frequency band along with the first frequency band. The processing device selectively notifies the terminal device of first information indicating that all of the second frequency bands are used, or second information indicating that not all of the second frequency bands are not used, from the base station apparatus.

### Advantageous Effects of Invention

An object of the present invention is to provide more efficient control when an unlicensed band is used and to provide control in which communication can be established, or be ensured, and can continue by stably using the unlicensed band.

When an unlicensed band is used, control with more efficiency and more flexible is provided, and communication is established, or ensured, and continues by stably using the unlicensed band. Thus, it is possible to realize higher speed communication.

### BRIEF DESCRIPTION OF DRAWINGS

FIG. 1 is a conceptual diagram illustrating a wireless communication system according to the present invention.

FIG. 2 is a schematic block diagram illustrating a structure of a base station apparatus 3 according to the present invention.

FIG. 3 is a schematic block diagram illustrating a structure of a mobile station apparatus 1 according to the present invention.

FIG. 4 is a diagram illustrating a combination of frequency bands, which is used as a cell of an unlicensed band in the present invention.

FIG. 5 is a diagram illustrating a combination of frequency bands, which is used as a cell of the unlicensed band in the present invention.

FIG. 6 is a diagram illustrating a notification and a control of control information in the unlicensed band in the present invention.

FIG. 7 is a diagram illustrating a notification and a control of the control information in the unlicensed band in the present invention.

FIG. 8 is a diagram illustrating a notification and a control of the control information in the unlicensed band in the present invention.

FIG. 9 is a diagram illustrating a notification and a control of the control information in the unlicensed band in the present invention.

FIG. 10 is a diagram illustrating a notification and a control of the control information in the unlicensed band in the present invention.

FIG. 11 is a diagram illustrating a notification and a control of the control information in the unlicensed band in the present invention.

FIG. 12 is a diagram illustrating a notification and a control of the control information in the unlicensed band in the present invention.

FIG. 13 is a diagram illustrating a control of the unlicensed band in the present invention.

FIG. 14 is a diagram illustrating a control of the unlicensed band in the present invention.

FIG. 15 is a diagram illustrating a control of the unlicensed band in the present invention.

FIG. 16 is a diagram illustrating a control of the unlicensed band in the present invention.

FIG. 17 is a diagram illustrating a control of the unlicensed band in the present invention.

FIG. 18 is a diagram illustrating a notification and a control of the control information in the unlicensed band in the present invention.

FIG. 19 is a diagram illustrating a notification and a control of the control information in the unlicensed band in the present invention.

FIG. 20 is a diagram illustrating a notification and a control of the control information in the unlicensed band in the present invention.

### DESCRIPTION OF EMBODIMENTS

### First Embodiment

Hereinafter, a first embodiment according to the present invention will be described with reference to the drawings. In this example, a configuring method and a controlling method of an unlicensed band will be described. Using a communication scheme applied to a cell of a licensed band (for example, to which LTE-A is applied and which is used for communication between a base station apparatus and a terminal device) in an unlicensed band is referred to below as using a cell of an unlicensed band. For example, applying a communication scheme (for example, LTE-A) the same as a communication scheme which is applied to a cell of a licensed band, to a frequency band of an unlicensed band, and using the communication scheme for communication with a base station is referred to as use of a frequency band as a cell of an unlicensed band. A base station, a terminal, an access point, and the like will be described.

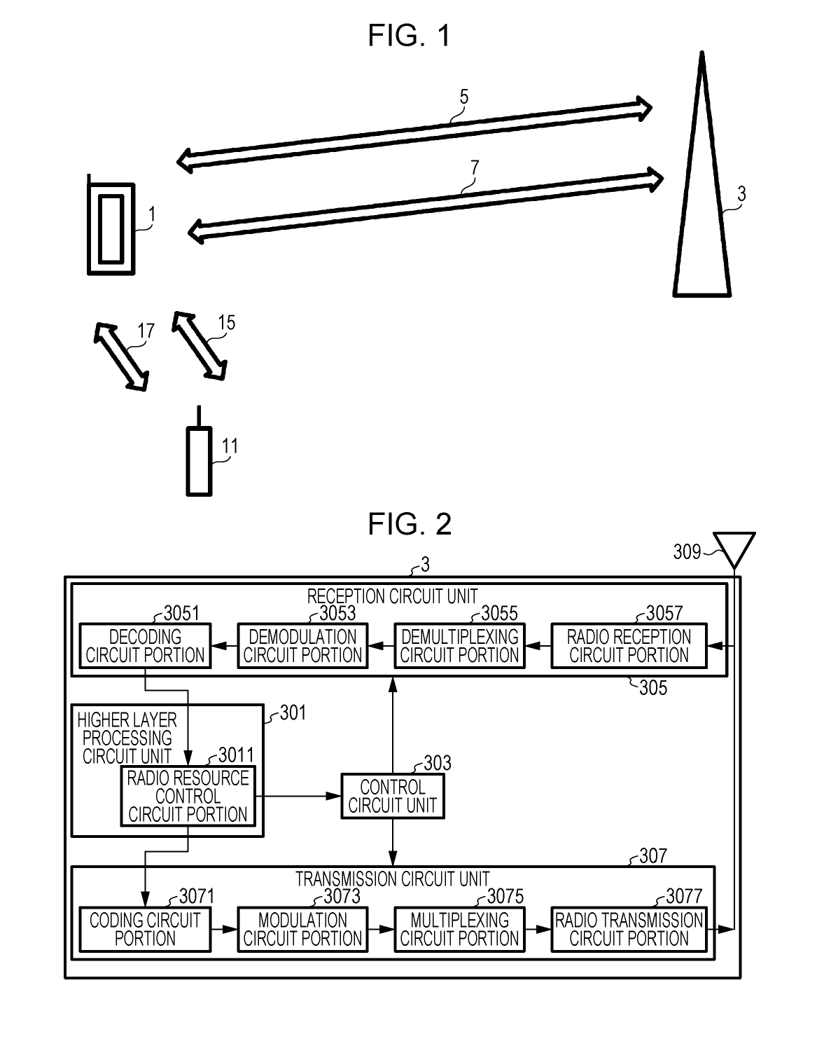

FIG. 1 is a conceptual diagram illustrating a wireless communication system according to the first embodiment in the present invention. In FIG. 1, the wireless communication system includes a terminal device 1 and a base station apparatus 3.

In this example, descriptions will be made on the assumption that the terminal device 1 is a portable phone. However, the terminal device 1 may be a communication circuit part of a device. For example, the terminal device 1 may be a communication device that is connected to a personal computer or mounted in the personal computer and that communicates with the base station apparatus 3. The terminal device 1 may be a communication device that is connected to a vehicle or a car navigation system or mounted in the vehicle or the car navigation system and that communicates with the base station apparatus 3. The above-described communication devices may be collectively referred to as user devices (user equipment). In addition, the terminal device 1 may be a communication device that is connected to a refrigerator or an air conditioner or mounted in the refrigerator or the air conditioner and that communicates with the base station apparatus 3. In FIG. 1, only the terminal device 1 is illustrated as the terminal device, for simple illustration. However, as the terminal device, a plurality of terminal devices may be included, that is, at least one terminal device may be included in the wireless communication system. Similarly, regarding the base station apparatus 3, a plurality of base station apparatuses is included in addition to the base station apparatus 3. That is, at least one base station apparatus is included in the wireless communication system. In FIG. 1, only one base station apparatus 3 is representatively illustrated. The base station apparatus 3 may be a base station which controls a macro cell in which a communication service can be provided in a wide area. The base station apparatus 3 may be a base station for a small cell in which communication can be provided only in a narrow area, or may be a base station for a closed subscriber group (CSG) cell designed so as to provide a communication service for a specific user. In other words, for example, the base station apparatus 3 may be a private base station or a home base station.

In FIG. 1, the base station apparatus 3 communicates with the terminal device 1 by using a licensed band. The communication is performed by using a serving cell 5 or a serving cell 7 as a cell of the licensed band, or by using the serving cell 5 and the serving cell 7 as the cell of the licensed band. Here, a serving cell which is actually used in a communication with the base station apparatus 3, such as the serving cell is simply described as a cell. That is, the serving cell 5 is simply described as a cell 5, and the serving cell 7 is simply described as a cell 7. The cell 7 is used as a primary cell (which will be described later), and the cell 5 is used as a secondary cell (which will be described later). Here, the cell 5 and the cell 7 may have a frequency band different from each other. The cell has a frequency band used when the base station apparatus 3 communicates with the terminal device 1 or another terminal device, or the cell is a unit used when the base station apparatus 3 manages a communication with the terminal device 1 which uses the frequency band.

Each cell may be constituted by a frequency band used in a communication of an uplink and a frequency band used in a communication of a downlink. In addition, each cell may be constituted only by a frequency band used in a communication of a downlink. The frequency band, that is, a frequency band constituting a cell (or frequency band used in a cell) is defined so as to be referred to as a component carrier. Particularly, a frequency band used in a communication of an uplink is defined so as to be referred to as an uplink component carrier (below ULCC), and a frequency band used in a communication of a downlink is defined so as to be referred to as a downlink component carrier (below DLCC). For example, the cell 7 which is a primary cell is constituted by a ULCC 7 and a DLCC 7. The cell 5 which is a secondary cell includes an ULCC 5 and a DLCC 5.

The base station apparatus 3 configures one of the configured cells 5 and 7, as a primary cell. The primary cell may be a cell used in an initial access for establishing a wireless connection, in a state where the wireless connection between the terminal device 1 and the base station apparatus 3 is not established. In this example, the cell 7 is assumed to be configured as a primary cell. A cell which is not the primary cell is referred to as a secondary cell. In FIG. 1, the secondary cell is the cell 5.

In FIG. 1, two cells are used, and one primary cell and one secondary cell are used. The number of cells to be used may be equal to or more than 3. However, as described above, since one primary cell is provided, constitution in which two secondary cells or more are used may be made. In addition, constitution in which only the cell 7 is used, that is, only the primary cell is used without using the secondary cell may be made. In other words, only one primary cell may be used, and one primary cell and at least one of secondary cells may be used. That is, a constitution in which the base station apparatus 3 and the terminal device 1 can communicate with each other by using a frequency band of one licensed band or more, as a frequency band to be used, may be made. In FIG. 1, as described above, a constitution in which one primary cell and one secondary cell are used is illustrated.

In this specification, a cell, particularly, a secondary cell may be constituted only from a DLCC without including an ULCC, as described above. For example, a cell 9 (not illustrated) may be used instead of the cell 5, or along with the cell 5, and a constitution only by a DLCC 9 without using an ULCC may be made for the cell 9. That is, the secondary cell may include at least a DLCC. The present invention will be made by, as described above, using a case where the cell 7 and the cell 5 are used, that is, a case where each of both of the primary cell and the secondary cell includes an ULCC and a DLCC, as an example, in FIG. 1.

In FIG. 1, an access point 11 of a wireless LAN is provided in the vicinity of the terminal device 1. The access point 11 can communicate with other devices, for example, a personal computer or a printer (not illustrated), by performing the carrier sense multiple access with collision avoidance (CSMA/CA) communication in accordance with, for example, IEEE 802.11n. The access point 11 functions as a wireless router, and thus can also communicate with the terminal device 1.

The access point 11 is connected to the Internet by a wired connection, for example, by using an optical fiber. The access point 11 is not limited to the wired connection, and may be connected to the Internet by using a wireless connection such as mobile WiMAX (IEEE 802.16e). The access point 11 can perform a communication, for example, by using one of frequency bands 15 and 17 or by using both of the frequency bands 15 and 17 in a communication with the terminal device 1. The access point 11 can use also a frequency band 16 (not illustrated). Here, the frequency bands 15, 16, and 17 may correspond to a frequency band belonging to an unlicensed band.

In FIG. 1, the access point 11 is defined so as to have a constitution of using three of the frequency band 15 of an unlicensed band, the frequency band 16, and the frequency band 17. The access point 11 may have a constitution in which communication with the terminal device 1 or another device such as a personal computer can be performed only by using one frequency band. The access point 11 may have a constitution in which communication is performed by selectively or collectively using two frequency bands or four frequency bands or more.

For the access point, a constitution in which communication with a plurality of devices is performed by using portions of a usable unlicensed band, respectively, may be made. For example, in FIG. 1, the access point 11 may communicate with the terminal device 1 by using the frequency band 15 and the frequency band 17, and the access point 11 may communicate with, for example, a personal computer by using the frequency band 16. The terminal device 1 can directly perform a wireless communication with the personal computer or a printer having a wireless interface, by using the frequency band 15 and the like, in accordance with the specification of 802.11n. The terminal device 1 may directly communicate with, another device (for example, a personal computer or a printer) without passing through the access point 11, by using the frequency band of an unlicensed band (for example, the frequency bands 15, 16, and 17).

FIG. 2 is a block diagram illustrating a structure of the base station apparatus 3. In FIG. 2, only a circuit portion for describing this application invention is extracted. This circuit portion corresponds to a representative circuit portion required for communicating with the base station apparatus 3, or a circuit portion which has a direct relation with the present invention. The base station apparatus 3 performs a communication with the terminal device 1 in accordance with LTE-A. Thus, each circuit portion as in FIG. 2 includes a circuit portion used in a communication in accordance with LTE-A. Since the access point 11 also uses the LTE-A communication scheme, the access point 11 is defined to have a circuit portion similar to that in FIG. 2, and descriptions for the structure of the access point 11 will be omitted. In order to perform LTE-A communication, the access point 11 may be replaced with another circuit or another circuit portion may be added. Descriptions for parts which do not directly influence this application invention, for example, a power supply circuit or a power switch, an operation unit, a display unit, a pilot lamp, and the like will be omitted.

Only one circuit portion is described. However, a constitution in which a plurality of circuit portions are used together may be made. For example, a constitution in which a plurality of antennae is used may be made. In FIG. 2, only one antenna is illustrated for simple descriptions.

As described above, the base station apparatus 3 includes a higher layer processing circuit unit 301, a control circuit unit 303, a reception circuit unit 305, a transmission circuit unit 307, and a transmit and receive antenna 309. The higher layer processing circuit unit 301 includes a radio resource control circuit portion 3011. The reception circuit unit 305 includes a decoding circuit portion 3051, a demodulation circuit portion 3053, a demultiplexing circuit portion 3055, and a radio reception circuit portion 3057. The transmission circuit unit 307 includes a coding circuit portion 3071, a modulation circuit portion 3073, a multiplexing circuit portion 3075, and a radio transmission circuit portion 3077.

The higher layer processing unit 301 performs processing of a medium access control (MAC) layer, a packet data convergence protocol (PDCP) layer, a radio link control (RLC) layer, and a radio resource control (RRC) layer. The higher layer processing circuit unit 301 generates information for controlling the reception circuit unit 305 and the transmission circuit unit 307, and outputs the generated information to the control circuit unit 303. The radio resource control circuit portion 3011 in the higher layer processing circuit unit 301 generates downlink data (transport block) mapped on a physical downlink control channel (PDSCH) of a downlink, an RRC signal, and an MAC CE. In addition, the radio resource control circuit portion 3011 acquires the downlink data, the RRC signal, and the MAC CE from a higher node, for example, a radio network controller (RNC, not illustrated). The radio resource control circuit portion 3011 outputs the downlink data, the RRC signal, and the MAC CE which have been generated, to the transmission circuit unit 307. The radio resource control circuit portion 3011 manages various types of setting information of the terminal device 1. For example, the radio resource control circuit portion 3011 manages an identifier (RNTI), for example, assigns a cell-specific radio network temporary identifier (C-RNTI) to the terminal device 1.

The radio resource control circuit portion 3011 manages a cell configured in the terminal device 1. The radio resource control circuit portion 3011 configures a DLCC and an ULCC (or only a DLCC) used in a communication, in each terminal device 1. The radio resource control circuit portion 3011 controls the transmission circuit unit 307 via the control circuit unit 303, and simultaneously outputs the control information to the transmission circuit unit 307 so as to perform a notification of control information required for a configuration of an RRC signal (below control information) by using the RRC signal.

The radio resource control circuit portion 3011 manages a cell (DLCC and ULCC, or only a DLCC) configured so as to be used in a communication with the terminal device 1, and manages a cell (ULCC or DLCC, or only a DLCC) configured so as not to be used in the communication. The radio resource control circuit portion 3011 can control resources of a component carrier in a unit of a cell, or a unit of a DLCC or an ULCC. The terminal device 1 can be notified of the control, by using, for example, RRC signaling for the terminal device 1.

The radio resource control circuit portion 3011 assigns a portion of a frequency band as a communication resource to the terminal device 1, so as to communicate with the terminal device 1 by using the assigned communication resource. The base station notifies the terminal device 1 of the assigned communication resource, by using a DLCC. In this embodiment, two types of communication resources are roughly provided. One type corresponds to a case where a frequency band of a licensed band is used, and another type corresponds to a case where an unlicensed band is used. Particularly, a communication resource assigned by using a portion of the licensed band is referred to as a first communication resource, and a communication resource assigned by using a portion or the entirety of the unlicensed band is referred to as a second communication resource. In other words, the radio resource control circuit portion 3011 performs a control in which a portion of the licensed band as a first communication resource is assigned to the terminal device 1, a portion of the unlicensed band as the second communication resource is assigned to the terminal device 1, and the assigned communication resources are used in a communication with the terminal device 1. Here, the base station apparatus 3 can communicate with the terminal device 1 by using one or both of the first communication resource and the second communication resource, as the communication resource.

As described above, the radio resource control management portion 3011 can perform a control of configuring a cell so as to be used in a communication, and not to be used in the communication. In the control, a cell (at least one or both of a DLCC and an ULCC) can be set to be a use state or a non-use state, as a control of the cell.

Here, the use state referred to as an activation state or an activated state which is a state where a portion of a frequency band to be used by scheduling is reserved or assigned as a communication resource, so as to enable a communication with the terminal device 1, and a state where a use in a communication with the terminal device 1 is possible. Being in the activated state is referred to as activating.

The non-use state is referred to as a deactivation state or a deactivated state which is a state where reserving or assigning some of cells or a portion of the frequency band as a communication resource by scheduling is not allowed, and is a state of not being used in a communication with the terminal device 1. Being in the deactivated state is referred to as deactivating.

Thus, the activated state may be referred to as a deactivatable state, and the deactivated state may be referred to as an activatable state.

The non-use state may be defined as a state of being released without being used as a cell. It is assumed that using a frequency band of the unlicensed band as a cell of the unlicensed band, or a state where the frequency band is usable means the activated state in a case where particular statements are not made below. In addition, it is assumed that starting a use means activating.

Conversely, it is assumed that not using a frequency band of the unlicensed band as a cell of the unlicensed band, a deactivated state where the use is stopped, or stopping the use means deactivating in a case where particular statements are not made.

That is, if a cell is activated and scheduled, the cell can be in a state of being used in a communication. If a cell is deactivated, the cell is in a state where, unless the cell is activated, scheduling of the cell is not possible and using the cell is not possible. In addition, activating a deactivated cell causes the cell to be in a use state where scheduling is possible, and to be in a state where a use in a communication with the terminal device 1 is possible.

The radio resource control circuit portion 3011 configures a DLCC to which control information relating to a cell which is used in a communication is mapped, in the terminal device 1. The radio resource control circuit portion 3011 controls the transmission circuit unit 307 via the control circuit unit 303, so as to notify the terminal device 1 of the control information relating to the configuration by using an RRC signal. The radio resource control circuit portion 3011 controls the transmission circuit unit 307 via the control circuit unit 303, so as to notify the terminal device 1 of the control information on a PDCCH or by using a MAC CE.

The control circuit unit 303 generates control signals for controlling the reception circuit unit 305 and the transmission circuit unit 307, based on the control information from the higher layer processing circuit unit 301. The control circuit unit 303 outputs the generated control signals to the reception circuit unit 305 and the transmission circuit unit 307, and controls the reception circuit unit 305 and the transmission circuit unit 307.

The reception circuit unit 305 receives reception signals from the terminal device 1 via the transmit and receive antenna 309. The reception circuit unit 305 separates, demodulates, decodes the received signals, and outputs information obtained by decoding to the higher layer processing circuit unit 301, in accordance with an input from the control circuit unit 303. The radio reception circuit portion 3057 converts (down-coverts) an uplink signal which has been received via the transmit and receive antenna 309, into a baseband signal by quadrature demodulation. The radio reception circuit portion 3057 removes an unnecessary frequency component, and controls an amplification level so as to maintain a signal level to be appropriate. The radio reception circuit portion 3057 performs quadrature demodulation based on an in-phase component and a quadrature component of the received signal, and converts an analog signal obtained by quadrature demodulation, into a digital signal. The radio reception circuit portion 3057 removes a component corresponding to a guard interval (GI), from the converted digital signal. The radio reception circuit portion 3057 performs fast Fourier transform (FFT) on a signal obtained by removing the guard interval, and extracts a signal in a frequency domain. The radio reception circuit portion 3057 outputs the extracted signal to the demultiplexing circuit portion 3055.

The demultiplexing circuit portion 3055 separates the signals input from the radio reception circuit portion 3057 into a physical uplink control channel (PUCCH), a physical uplink shared channel (PUSCH), and a signal such as an uplink reference signal. The separation is performed based on assignment information of radio resources, which is determined in advance by the radio resource control circuit portion 3011 in the base station apparatus 3, and is included in an uplink grant of which each terminal device 1 is notified, or is the uplink grant. The demultiplexing circuit portion 3055 performs channel compensation of the PUCCH and the PUSCH, based on an estimated value of the channel, which has been input from a channel measurement circuit portion (not illustrated). The demultiplexing circuit portion 3055 outputs the separated uplink reference signal to the channel measurement circuit portion (not illustrated).

The demodulation circuit portion 3053 performs inverse discrete Fourier transform (IDFT) on the PUSCH, and acquires modulation symbols. The demodulation circuit portion 3053 demodulates the reception signal by using each of the modulation symbols of the PUCCH and the PUSCH, and by using a modulation scheme. The modulation scheme is a predetermined modulation scheme such as binary phase shift keying (BPSK), QPSK, 16QAM, 64QAM, 256QAM, and the like, or is a modulation scheme of which each terminal device 1 is notified in an uplink grant by the base station apparatus 3.

The decoding circuit portion 3051 decodes coding bits of the PUCCH and the PUSCH, which are obtained by demodulation, at a coding rate. The coding rate is for a predetermined coding scheme. The coding rate is predetermined or a coding rate of which the terminal device 1 is previously notified in an uplink grant by the base station apparatus 3. The decoding circuit portion 3051 outputs uplink data obtained by decoding, and uplink control information to the higher layer processing circuit unit 301.

The transmission circuit unit 307 generates a downlink reference signal, codes various types of control information (for example, downlink control information, downlink data, and control information) which have been input from the higher layer processing circuit unit 301, in accordance with an input from the control circuit unit 303. The transmission circuit unit 307 performs modulation, multiplexes a physical HARQ indicator channel (PHICH), a PDCCH, a PDSCH, and a downlink reference signal, and transmits a signal obtained by multiplexing, to the terminal device 1 via the transmit and receive antenna 309.

The coding circuit portion 3071 codes the control information input from the higher layer processing circuit unit 301, and the downlink data. The coding circuit portion 3071 performs coding by using a predetermined coding scheme such as block coding, convolutional coding, and turbo coding, or by using a coding scheme which is determined by the radio resource control circuit portion 3011.

The modulation circuit portion 3073 modulates the coding bits input from the coding circuit portion 3071. The modulation is performed by using a predetermined modulation scheme such as BPSK, QPSK, 16QAM, 64QAM, and 256QAM, or by using a modulation scheme which is determined by the radio resource control circuit portion 3011.

The multiplexing circuit portion 3075 multiplexes the modulated channel and the generated downlink reference signal.

The radio transmission portion 3077 performs inverse fast Fourier transform (IFFT) on the multiplexed modulation symbols and the like, so as to generate OFDM symbols. The radio transmission portion 3077 adds a cyclic prefix (CP) to the generated OFDM symbol, so as to generate a baseband digital signal. The radio transmission portion 3077 converts the baseband digital signal into an analog signal, and removes an extra frequency component by using a low-pass filter. The radio transmission portion 3077 performs up-conversion into a carrier frequency, amplifies power thereof, and outputs and transmits a signal having amplified power, to the transmit and receive antenna unit 309.

Each of the circuit portions may be constituted by only a circuit (for example, a circuit device such as an application specific integrated circuit (ASIC)) configured so as to cause dedicated circuits to respectively realize the above-described functions, and functions which will be described below. In addition, the circuit portions may be constituted as follows: some of the functions may be constituted by using a general-purpose processing circuit, and a portion of processing or some of the functions performed by each of the circuit portions may be realized in software by using the general-purpose circuit, and thus the functions may be realized by both of the dedicated circuit portions and software processing. Further, the circuit portions may be constituted by using a general-purpose processing circuit without the dedicated circuit portion, so as to cause the functions to be realized by using software. Particularly, in a case of using the general-purpose processing circuit, a general-purpose circuit portion which is dedicated for each of the circuit portions may be disposed. However, one general processing portion which performs the total processing may be disposed, or a plurality of general processing portions which respectively perform portions of the processing may be disposed, so as to perform the above-described processing.

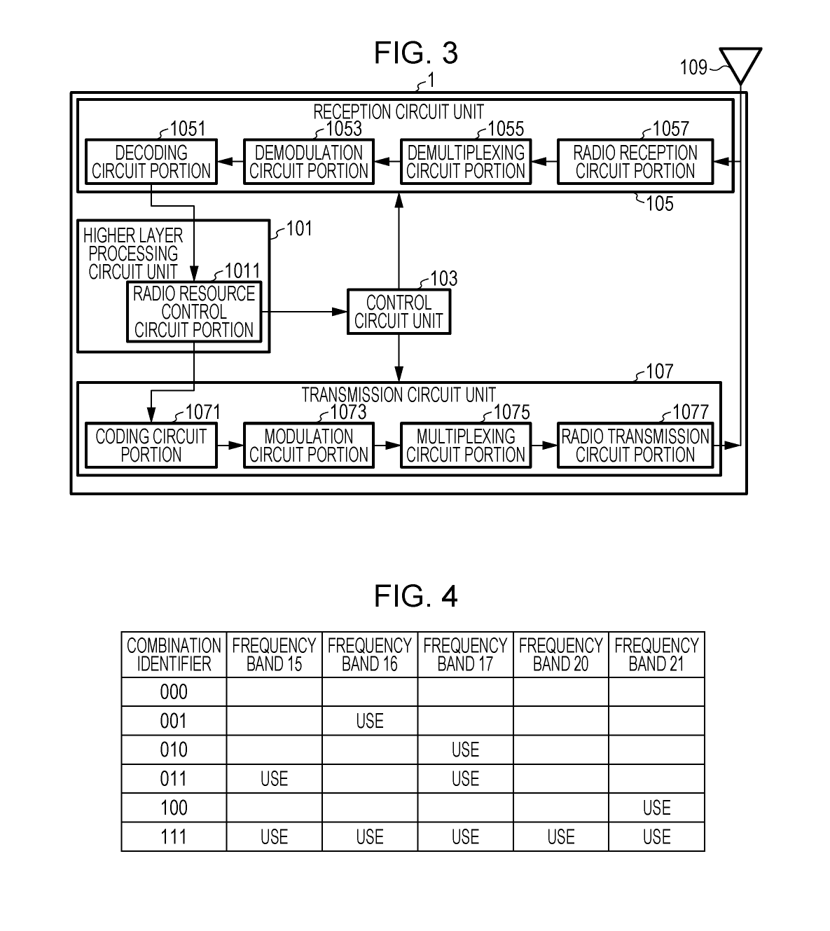

FIG. 3 is a schematic block diagram illustrating the terminal device 1 according to the present invention. In FIG. 3, only a circuit portion required for describing this application invention is extracted. This circuit portion corresponds to a representative circuit portion required for communicating with the base station apparatus 3, or a circuit portion which has a direct relation with the present invention. Descriptions for parts which do not directly influence this application invention, for example, a power supply circuit or a power switch, an operation unit, a display unit, a pilot lamp, and the like will be omitted.

Only one circuit portion is illustrated as the circuit portion. However, a constitution in which a plurality of circuit portions are used together may be made. For example, a constitution in which a plurality of antennae is used may be made. In FIG. 3, only one antenna is illustrated for simple descriptions.

As illustrated in FIG. 3, the terminal device 1 includes a higher layer processing circuit unit 101, a control circuit unit 103, a reception circuit unit 105, a transmission circuit unit 107, and a transmit and receive antenna 109. The higher layer processing circuit unit 101 includes a radio resource control circuit portion 1011. The reception circuit unit 105 includes a decoding circuit portion 1051, a demodulation circuit portion 1053, a demultiplexing circuit portion 1055, and a radio reception circuit portion 1057. The transmission circuit unit 107 includes a coding circuit portion 1071, a modulation circuit portion 1073, a multiplexing circuit portion 1075, and a radio transmission circuit portion 1077.

The higher layer processing circuit unit 101 outputs an uplink data which has been generated by an operation and the like of a user, an RRC signal, or a MAC CE to the transmission circuit unit 107. The higher layer processing circuit unit 101 performs processing of a medium access control (MAC) layer, a packet data convergence protocol (PDCP) layer, a radio link control (RLC) layer, and a radio resource control (RRC) layer. The higher layer processing circuit unit 101 generates information for controlling the reception circuit unit 105 and the transmission circuit unit 107 based on downlink control information which has been received on a PDCCH, and outputs the generated information to the control circuit unit 103. The radio resource control circuit portion 1011 in the higher layer processing circuit unit 101 manages various types of configuration information of the terminal device 1. For example, the radio resource control circuit portion 1011 manages an identifier such as a C-RNTI. The radio resource control circuit portion 1011 generates information mapped on each uplink channel, and outputs the generated information to the transmission circuit unit 107.

The radio resource control circuit portion 1011 manages a cell in accordance with a notification using an RRC signal of which a notification is performed from the base station apparatus 3. The radio resource control circuit portion 1011 can control component carriers in a unit of a cell or in a unit of a DLCC or an ULCC. Here, as described above, the management of a cell includes a control of a use state or a non-use state in a unit of a cell, or in a unit of an ULCC or a DLCC, more specifically, includes a control of activation or deactivation, or connection establishment or release, for example.

The control circuit unit 103 generates control signals for controlling the reception circuit unit 105 and the transmission circuit unit 107, based on information from the higher layer processing circuit unit 101. The control circuit unit 103 outputs the generated control signals to the reception circuit unit 105 and the transmission circuit unit 107, so as to control the reception circuit unit 105 and the transmission circuit unit 107. The reception circuit unit 105 separates, demodulates, decodes the reception signal which has been received from the base station apparatus 3 via the transmit and receive antenna 109, in accordance with the control signals input from the control circuit unit 103, and outputs information obtained by decoding, to the higher layer processing circuit unit 101.

The radio reception circuit portion 1057 converts (down-coverts) a downlink signal which has been received via the transmit and receive antenna 109, into a signal of a baseband frequency. The radio reception circuit portion 1057 removes an unnecessary frequency component, and controls an amplification level so as to maintain a signal level to be appropriate. The radio reception circuit portion 1057 performs quadrature demodulation based on an in-phase component and a quadrature component of the received signal, and converts an analog signal obtained by quadrature demodulation, into a digital signal. The radio reception circuit portion 1057 removes a component corresponding to a guard interval (GI), from the converted digital signal. The radio reception circuit portion 1057 performs fast Fourier transform (FFT) on a signal obtained by removing the guard interval, and extracts a signal in the frequency domain.

The demodulation circuit portion 1053 demodulates a PHICH by using the binary phase shift keying (BPSK) modulation scheme, and outputs the demodulated PHICH to the decoding circuit portion 1051. The decoding circuit portion 1051 decodes the PHICH for the terminal device 1, and outputs the decoded HARQ indicator to the higher layer processing circuit unit 101. The demodulation circuit portion 1053 demodulates a PDCCH by using the QPSK modulation scheme, and outputs the demodulated PDCCH to the decoding circuit portion 1051. The decoding circuit portion 1051 attempts to perform blind decoding of the PDCCH. In a case where the attempt of the blind decoding succeeds, the decoding circuit portion 1051 outputs the decoded downlink control information and an RNTI which is included in the downlink control information, to the higher layer processing circuit unit 101.

The demodulation circuit portion 1053 demodulates a PDSCH by using a modulation scheme such as quadrature phase shift keying (QPSK), quadrature amplitude modulation (16QAM), 64QAM, and 256QAM, of which a notification is performed by resource assignment (scheduling information) of a downlink, and outputs the generated PDSCH to the decoding circuit portion 1051. The decoding circuit portion 1051 performs decoding based on information which relates to a coding rate of which a notification is performed in the downlink control information, and outputs downlink data (transport block) obtained by decoding, to the higher layer processing circuit unit 101.

The transmission circuit unit 107 generates an uplink reference signal, codes and modulates uplink data (transport block) input from the higher layer processing circuit unit 101, and multiplexes a PUCCH, a PUSCH, and the generated uplink reference signal, in accordance with the control signals input from the control circuit unit 103. The transmission circuit unit 107 transmits a signal obtained by multiplexing, to the base station apparatus 3 via the transmit and receive antenna 109. The coding circuit portion 1071 codes uplink control information input from the higher layer processing circuit unit 101, by using a coding scheme such as convolutional coding and block coding. The coding circuit portion 1071 performs turbo coding on the uplink data, based on information which relates to a coding rate of which a notification is performed in the uplink grant. The modulation circuit portion 1073 modulates coding bits input from the coding circuit portion 1071. The modulation is performed by using a modulation scheme such as BPSK, QPSK, 16QAM, and 64QAM, of which a notification is performed in the downlink control information, or by using a modulation scheme which is predetermined for each channel.

The radio transmission circuit portion 1077 performs inverse fast Fourier transform (IFFT) on the multiplexed signal, so as to perform modulation of the SC-FDMA type. The radio transmission circuit portion 1077 adds a CP to a SC-FDMA symbol obtained by SC-FDMA modulation, and generates a baseband digital signal. The radio transmission circuit portion 1077 converts the baseband digital signal to an analog signal, performs conversion (up-conversion) into a signal having a high frequency, and removes an extra frequency component. The radio transmission circuit portion 1077 amplifies power thereof, and outputs and transmits a signal having the amplified power, to the transmit and receive antenna 109.

Each of the circuit portions may be constituted by only a circuit (for example, a circuit device such as an application specific integrated circuit (ASIC)) configured so as to cause dedicated circuits to respectively realize the above-described functions, and functions which will be described below. In addition, the circuit portions may be constituted as follows: some of the functions may be constituted by using a general-purpose processing circuit, and a portion of processing or some of the functions performed by each of the circuit portions may be realized in software by using the general-purpose circuit, and thus the functions may be realized by both of the dedicated circuit portions and software processing. Further, the circuit portions may be constituted by using a general-purpose processing circuit without the dedicated circuit portion, so as to cause the functions to be realized by using software. Particularly, in a case of using the general-purpose processing circuit, a general-purpose circuit portion which is dedicated for each of the circuit portions may be disposed. However, one general processing portion which performs the total processing may be disposed, or a plurality of general processing portions which respectively perform portions of the processing may be disposed, so as to perform the above-described processing.

Next, in this example, a configuring method and a using method of an unlicensed band will be described. The base station apparatus 3 notifies the terminal device 1 of the required control information when the unlicensed band is used. The control information may include at least one or both of licensed-band control information and unlicensed-band control information. The licensed-band control information is first control information including control information (or control information required for a frequency band of a licensed band) which relates to the cell 5 or the cell 7 which uses the licensed band, or a cell (below, cell of the licensed band) using another licensed band. The unlicensed-band control information is second control information which is control information (or control information required for a frequency band of the unlicensed band) which relates to a cell (below, cell of the unlicensed band) using the unlicensed band.

The terminal device 1 may be notified of the unlicensed-band control information as control information with the licensed-band control information, from the base station apparatus 3. The terminal device 1 may be notified of the unlicensed-band control information by using control information without the licensed-band control information. That is, the control information of which the terminal device 1 is notified from the base station apparatus 3 may include one or both of the licensed-band control information and the unlicensed-band control information.

Next, a control performed in a case where using the unlicensed band is started in a communication between the base station apparatus 3 and the terminal device 1 will be described. Similarly to the licensed band, regarding the unlicensed band, the base station apparatus 3 performs a control or management considering one cell which is constituted by a frequency band of the unlicensed band with a frequency band of the unlicensed band as a unit (cell). This cell is referred below to as a cell of an unlicensed band. Particularly, a frequency band constituting the cell of an unlicensed band when the terminal device 1 applies the same communication scheme as a cell of a licensed band, to the cell of an unlicensed band, so as to communicate with the base station apparatus 3 is referred to as a frequency band as a cell of a frequency band, or is simply referred to as a cell of an unlicensed band. The frequency band constituting the cell of an unlicensed band may be referred to as a frequency band used as a cell of an unlicensed band, or a frequency band as a cell of an unlicensed band. Hereinafter, these cases may be referred to as “using a frequency band as a cell of an unlicensed band”.

In a communication between the base station apparatus 3 and the terminal device 1, the unlicensed-band control information is used, for example, in a case where using the frequency bands 15 or 17 as a cell, between the terminal device 1 and the base station apparatus 3. That is, when the base station apparatus 3 starts using the unlicensed band in a communication with the terminal device 1, the base station apparatus 3 notifies the terminal device 1 of the unlicensed-band control information. More specifically, the unlicensed-band control information is included in the control information, is generated by the radio resource control circuit portion 3011. The transmission circuit unit 307 notifies the terminal device 1 of the unlicensed-band control information.

The radio resource control circuit 3011 in the base station apparatus 3 is assumed to determine a use start of a cell of an unlicensed band, and to select the frequency band 17 as the cell of an unlicensed band. Here, the use start is defined so as to indicate that a frequency band of an unlicensed band is activated as a cell of an unlicensed band (which will be described later). The base station apparatus 3 notifies the terminal device 1 of newly starting a use of the frequency band 17. Specifically, the base station apparatus 3 generates information indicating the frequency band 17, as the unlicensed-band control information, and notifies the terminal device 1 of the generated information. The base station apparatus 3 notifies the terminal device 1 of information (may be referred to as information for identifying a cell of an unlicensed band, or as information indicating a frequency band of which a dedicated use is not possible) indicating a cell of an unlicensed band to be used, with being included in the control information, as the unlicensed-band control information in this case. Since using the frequency band 17 as a cell of the unlicensed band is started, here, information for identifying the frequency band 17 is included as the information indicating a cell of an unlicensed band. The information for identifying the frequency band 17 may be information regarding, for example, a frequency of the frequency band 17.

As information regarding a frequency, for example, information of a frequency band may be provided. The information of a frequency band may be expressed as information indicating a frequency, for example. As the information indicating a frequency, a center frequency or a bandwidth may be used, or an upper limit value and a lower limit value of a frequency band may be used. In addition, in a case where the center frequency and the frequency bandwidth are uniquely determined, the frequency indicated by the information may be only the center frequency, and is not particularly limited thereto as long as the frequency band can be specified. The center frequency is simply described as a frequency. In a case where a plurality of frequency bands is used together, a notification of a plurality of indices or frequencies, or a notification of both of the plurality of indices and the plurality of frequencies may be performed.

If an identifier or an index which has been previously prepared is provided as the frequency, the prepared identifier or index may be substituted or used together. That is, the information regarding a frequency may be information which can directly or indirectly specify frequency information, and can be restated as information indicating the frequency information or as frequency information. For example, in a case where the band of 2.4 GHz, the band of 5.2 GHz, and the band of 5.5 GHz are used as frequencies, if an index 1 is previously prepared for the band of 2.4 GHz, an index 2 is previously prepared for the band of 5.2 GHz, and an index 3 is previously prepared for the band of 5.5 GHz, a constitution in which the base station apparatus 3 notifies the terminal device 1 of any one of the indices 1 to 3 may be made.

Correlation between the identifier and the index may not be determined in advance, and a frequency may be specified based on the identifier or the index. For example, the frequency band of 2.4 GHz may be specified by using an index 24, the frequency band of 5.2 GHz may be specified by using an index 52, and the frequency band of 5.5 GHz may be specified by using an index 55. As described above, a constitution in which the frequency information is specified based on the index, and a specified conversion expression or relation may be made. In this case, for example, an RRC connection Reconfiguration message (see TS36.331 v10.3.0) which is a known message in the LTE-A can be used. In this message, in a case where a new cell is added, the base station apparatus 3 can instruct the terminal device 1 of adding the cell, by using a cell number and the frequency information.

Here, an instruction of whether or not all of frequency bands which are usable as a cell of an unlicensed band are used may be performed. In a case where all of frequency bands which are usable as a cell of an unlicensed band are used, a notification of pieces of frequency information for all of the frequency bands which are usable as the cell of an unlicensed band may be performed, or a notification of the frequency may be simply performed. Conversely, in a case where not all of the frequency bands which are usable as the cell of an unlicensed band are used, a notification of pieces of frequency information for all of the frequency bands which are usable as the cell of an unlicensed band may not be performed, or a notification of the frequency may not be simply performed.

A channel constituted by fragmenting one frequency band may be defined as the frequency band. For example, the frequency band of 2.4 GHz is divided into, for example, n frequency bands, and an identifier of each of the frequency bands obtained by division or information of the frequency thereof may be used. The identifier or information may be determined in combination with the specification (for example, 802.11n) applied to a communication of another device which uses the unlicensed band to be used.

FIG. 4 illustrates a method of designating a cell as the unlicensed-band control information, that is, a method of designating a frequency band to be used as the cell of an unlicensed band. FIG. 4 illustrates the frequency bands 15, 16, 17, 20, and 21 as usable unlicensed bands. In this embodiment, a frequency band allowed to be used by the terminal device 1 is the frequency bands 15, 16, and 17, and the terminal device 1 does not use the frequency bands 20 and 21. However, a constitution as follows may be made. That is, in a case of another terminal device 1A (not illustrated), only the frequency bands 20 and 21 can be used, not the frequency bands 15, 16, and 17. In a case of a terminal device 1B (not illustrated), the frequency bands 20 and 21 can be also used in addition to the frequency bands 15, 16, and 17. In a case of a terminal device 1C (not illustrated), only the frequency bands 17 and 21 can be used. In addition, a terminal device having a simple constitution in which using the unlicensed band is not possible may be provided.

The terminal device and the base station apparatus 3 which are set so as to cause using of the unlicensed band not to be possible may communicate with each other by using only the licensed band, and thus, in this specification, descriptions thereof will be omitted. A frequency band of the unlicensed band, which is usable along with a terminal device depends on an element such as a frequency band supported by the terminal device. Thus, in the present invention, the frequency band of the unlicensed band is not particularly limited.

In FIG. 4, regarding the frequency bands, a combination of “use” and “unuse” is generated in the unlicensed band, and an identifier (below, combination identifier) is assigned to each combination. A relation between a combination and a combination identifier may be determined in advance, and may be commonly used in the base station apparatus 3 and the terminal device 1. For example, a combination identifier 010 indicates that only the frequency band 17 is used as the cell of the unlicensed band. When the cell of the unlicensed band to be used is changed, for example, when a change from the frequency band 17 to the frequency band 16 is performed, the combination identifier 001 is transmitted to the terminal device 1, and thus a frequency band which is used as the cell of the unlicensed band may be changed from the frequency band 17 to the frequency band 16. As described above, the combination identifier is transmitted, and thus it is possible to perform an instruction as follows: using a frequency band as the cell of the unlicensed band; a change to unused; adding a frequency band to be used; deleting (or excluding, that is, setting the frequency band to be unused) a frequency band to be used; and stopping of a use as the cell of the unlicensed band. Here, the combination may be a combination relating to at least two or more of frequency bands which are used as the cell of the unlicensed band. However, as illustrated by 001 or 010 in FIG. 4, the combination may be used as an identifier indicating a frequency band which is used as an independent cell of the unlicensed band. The combination identifier may be expressed as information indicating a frequency band which is used as the cell of the unlicensed band to be used. The combination identifier indicates a frequency band used as the cell of the unlicensed band. In FIG. 4, regarding the frequency bands 20 and 21, a combination is defined. However, as described above, the combination identifier corresponds to a combination used for a terminal device which supports the frequency band 20 or 21. In addition, the combination is also used in a case where the terminal device 1 moves to a communication environment in which the frequency bands 20 and 21 which are unlicensed bands are used. However, as described above, since the terminal device 1 is a device in which using the frequency bands 20 and 21 is not possible, a configuration relating to the frequency band 20 or 21 may be ignored.

Regarding all combinations which are used or are not used (set to be unused) for the frequency band, combination identifiers are not necessarily configured. For example, in FIG. 4, combinations relating to a use status of five frequency bands are prepared. However, identifiers are not assigned to the prepared combinations, but an identifier is assigned to only the combination determined to be necessary. Thus, it is possible to reduce the number of bits for the combination identifier.

For example, in FIG. 4, a combination relating to a use of the five frequency bands is defined, and 5 bits are required for expressing all combinations. However, in FIG. 4, the combination identifier is expressed by using 3 bits. In FIG. 4, the number of bits to be used is 3, and thus 8 combinations may be illustrated. However, regarding all combinations which can be expressed by combination identifiers, it is not necessary that combinations of frequency bands to be used are assigned.

In FIG. 4, only 6 identifiers are provided, and specifically, 101 and 110 are not provided. This does not indicate that the reason that using 101 and 110 are not possible exists. The 6 identifiers are provided and reserved, for example, in a case where a frequency band 22 and the like, other than the frequency bands 15 to 21 as the cell of an unlicensed band is changed so as to be used as the cell of an unlicensed band. In addition, the 6 identifiers may be used in a case where 101 and 110 are wanted to be differently used for a frequency band which is usable as a known unlicensed band.

For example, the frequency band 20 is not singly used in FIG. 4. However, if it is necessary that the frequency band 20 is singly used as the cell of an unlicensed band, the base station apparatus 3 may assign the frequency band 20 to the terminal device, and use the frequency band 20 by using an identifier which has currently not used, for example, the combination identifier 101 performs assignment to the terminal device 1 for a single use of the frequency band 20, and thus the base station apparatus 3 may instruct the terminal device 1 to singly use the frequency band 20. In addition, in a case where the frequency bands 15 and 16 which correspond to a combination of frequency bands which are not provided in FIG. 4 are used, the base station apparatus 3 may instruct the terminal device 1 to use the frequency bands 15 and 16, by using an identifier (which has been currently not used), for example, by using the combination identifier 110.

A use control of the unlicensed band is allowed as follows, by using the constitution illustrated in FIG. 4. Since the unlicensed band is a band of which dedicated use is not possible as described above, a viewpoint in that it is not desirable that the base station apparatus 3 and the terminal device 1 monopolize the unlicensed band for a long time may be provided.

In a case where the terminal device 1 and the base station apparatus 3 temporarily handle user data having a significantly large volume, the base station apparatus 3 notifies the terminal device 1 of, for example, the combination identifier 011, and uses the frequency bands 15 and 17 as the cell of an unlicensed band. The base station apparatus 3 notifies the terminal device 1 of 010 as a combination identifier, at a point of time when a communication of data having a significantly large volume is ended. The base station apparatus 3 sets only the frequency band 17 to be a frequency band which is used as the cell of an unlicensed band, and releases the frequency band 15. In addition to the terminal device 1, other devices are also brought back to a usable state.

Conversely, for example, in a case where only the frequency band 17 has been currently used, if a communication of data having a large volume is temporarily required, the base station apparatus 3 may notify the terminal device 1 of 011 as a combination identifier, and thus the frequency bands 15 and 17 may be used as the cell of an unlicensed band, in a communication between the base station apparatus 3 and the terminal device 1. As described above, the base station apparatus 3 notifies the terminal device 1 of 010 as a combination identifier, at a point of time when the communication of data having a significantly large volume is ended. The base station apparatus 3 sets only the frequency band 17 to be a frequency band which is used as the cell of an unlicensed band, and releases the frequency band 15. In addition to the terminal device 1, other devices are also brought back to a usable state. Further, the base station apparatus 3 may notify the terminal device 1 of the combination identifier 001, and thus perform a change so as to use only the frequency band 16 as the cell of an unlicensed band. Further, the base station apparatus 3 may notify the terminal device 1 of the combination identifier 000, and thus all frequency bands of the unlicensed band, as the cell of the unlicensed band may be configured so as to be in the non-use state. In such meaning, 000 may be referred to as information which does not indicate all frequency bands as frequency bands which are used as the cell of an unlicensed band, or as information which does not indicate all frequency bands as the cell of an unlicensed band.

In this example, a notification of a combination identifier as the unlicensed-band control information is performed from the base station apparatus 3 to the terminal device 1, based on FIG. 4. In a case where the base station apparatus 3 uses the frequency band 17 as an unlicensed band, 010 is selected as the combination identifier.

That is, when the base station apparatus 3 starts a use of the frequency band 17 as an unlicensed band, the base station apparatus 3 notifies a terminal of the combination identifier 010 as the unlicensed-band control information, with being included in control information, in order to notify the terminal device 1 that using the frequency band 17 as the cell of an unlicensed band is started.

The terminal receives the control information, and thus performs a control in accordance with the unlicensed-band control information in the control information, so as to be in a state (use state) where a frequency band is used as the cell of an unlicensed band, or in a state (non-use state) where the frequency band is not used as the cell of an unlicensed band. More specifically, in a case where control information received by the reception circuit unit 105 of the terminal device 1 includes the unlicensed-band control information, the radio resource control circuit portion 1011 performs a control in accordance with the combination identifier which is the unlicensed-band control information, so as to use the frequency band as the cell of an unlicensed band or not to use the frequency band as the cell of an unlicensed band.

In this example, configuring is performed so as to receive the combination identifier 010 as the unlicensed-band control information, from the base station apparatus 3, and to use the frequency band 17 as the cell of an unlicensed band, in accordance with the identifier.

In a case where the base station apparatus 3 performs determination so as to cause the terminal device 1 to use all usable frequency bands as the cell of an unlicensed band, the base station apparatus 3 performs a notification of a combination identifier 111 as information indicating all of the frequency bands of the unlicensed band. The combination identifier 111 is unlicensed-band control information in the control information. The terminal device 1 receives the control information, and performs a control so as to use the frequency bands 15, 16, and 17 which are all of the usable frequency bands, as the cell of an unlicensed band.

Here, a cell of an unlicensed band will be described. As described above, the unlicensed band is a frequency band of which a dedicated use is not permitted in a communication between the base station apparatus 3 and the terminal device 1. Further, the unlicensed band is a frequency band which can be used by users who are unspecified individuals. Thus, it is not desirable that the users who are the unspecified individuals influence a communication which is a communication between the base station apparatus 3 and the terminal device 1, and uses the unlicensed band.

For example, a case where a CSMA/CA communication using the frequency band 15 is performed in the vicinity of the terminal device 1 when the terminal device 1 communicates with the base station apparatus 3 by using the frequency band 15 as the cell of the unlicensed band, particularly, when the terminal device 1 transmits data to the base station apparatus 3 by using the frequency band 15, that is, when the terminal device 1 performs a communication of an uplink can be assumed.

Particularly, in a case where the base station apparatus 3 is a base station of a macro cell, transmitted power from the terminal device 1 to the base station apparatus 3 may be significantly larger than power used in the CSMA/CA communication, and may influence the CSMA/CA communication. For example, a case where deterioration of communication quality, for example, causing an interference in the CSMA/CA communication is caused may be provided.

An interference which occurs by transmission of the terminal device 1 and is applied to another device may occur by a communication of an uplink which uses the cell of the unlicensed band, that is, by a communication which uses an ULCC. Thus, a DLCC and an ULCC may be used as the cell of the unlicensed band. However, the cell may be defined so as to be constituted by only using a DLCC. In addition, in a case where a plurality of frequency bands is used as the cell of the unlicensed band, an ULCC and a DLCC are not used in all of the frequency bands. Only a DLCC without using an ULCC may be used in a cell of at least one of unlicensed bands, or in a cell of all of the unlicensed bands.

For example, in a case where the base station apparatus 3 is a base station of a macro cell, all ULCC are not included as the cell of the unlicensed band, and only a DLCC may be constituted. In a case where the base station apparatus 3 is a base station of a home base station or a small cell, a constitution by using a DLCC and an ULCC may be made in the cell of all unlicensed bands. In addition, a constitution in which a portion thereof is constituted by a DLCC and an ULCC, and the remaining is constituted only by a DLCC.

For example, in a case where a base station which performs a communication in a case of using the combination identifier in FIG. 4 is a base station of a macro cell, that is, in a case where the base station apparatus 3 is the base station of a macro cell, even when an explicit instruction is not performed, the cell of an unlicensed band is defined so as to be for a DLCC, and the base station apparatus 3 uses only a DLCC of each of the frequency bands (frequency bands 15, 16, and 17).

The terminal device 1 performs a control without using an ULCC, in all of the frequency bands, that is, the frequency bands 15, 16, and 17. That is, the terminal device 1 does not perform processing of an uplink from the base station apparatus 3, for the frequency bands 15, 16, and 17. Actually, in a frequency band in which the terminal device 1 performs reception processing, configuring is performed in accordance with a combination identifier transmitted from the base station apparatus 3 to the terminal device 1. That is, the terminal device 1 receives a DLCC only in a frequency band indicated by the combination identifier which has been transmitted from the base station apparatus 3.

In a case where the base station apparatus 3 is a home base station, even when an explicit instruction is not performed, the cell of an unlicensed band is defined so as to be for a DLCC and an ULCC, and the base station apparatus 3 uses a DLCC and an ULCC of each of the frequency bands (frequency bands 15, 16, and 17). The terminal device 1 may perform a control so as to use the ULCC and the DLCC in a frequency band indicated by a combination identifier, for all of the frequency bands.

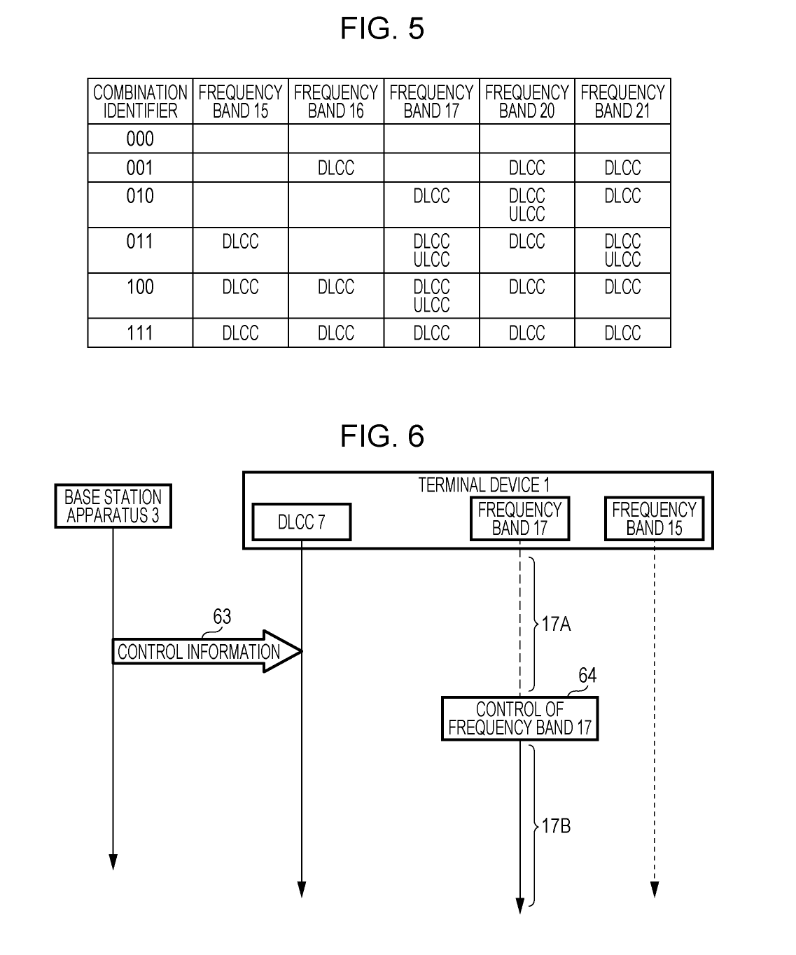

FIG. 5 illustrates another example. Regarding the use status of the frequency band, and the use status of the ULCC and the DLCC, significantly many combinations are provided. However, similarly to consideration in FIG. 4, the combination is limited to a necessary combination among combinations of the use status of the frequency band and the use status of the ULCC and the DLCC.

For example, in a case where the terminal device 1 is notified of the combination identifier 010 as the unlicensed-band control information, the terminal device 1 performs a control so as to use only the frequency band 17 as the cell of the unlicensed band, and to use only a DLCC without using an ULCC. In addition, in a case where the terminal device 1 is notified of the combination identifier 011 as the unlicensed-band control information, the terminal device 1 performs a control so as to use the frequency band 17 and the frequency band 15 as the cell of the unlicensed band, and particularly, performs a control so as to use only a DLCC without using an ULCC, in the frequency band 15.

Even in this constitution, for example, even in a case where a notification of the combination identifier 011 is performed, for example, in a case where the base station apparatus 3 is the base station of a macro cell, control may be performed so as to cause only a DLCC to be in the unuse state without using an ULCC, even when an explicit instruction is not performed from the base station apparatus 3. Similarly to the case of FIG. 4, a combination identifier which has not been used is just reserved.

In FIG. 4 or 5, the combination identifier is used for designating a frequency band which is to be used as the cell of an unlicensed band. Particularly, in a case where all frequency bands are used as unlicensed bands, 111 is used as a combination identifier which is information indicating all of the frequency bands of the unlicensed band. As in this example, in a case where frequency bands which is usable as the cell of an unlicensed band by the terminal device 1 are only three bands of the frequency bands 15, 16, and 17, 111 indicates that only the three usable frequency bands are used.

In a case where the terminal device 1A (not illustrated) is in the process of communicating with the base station apparatus 3, and the terminal device 1A can use the frequency bands 20 and 21 as the cell of an unlicensed band, if the combination identifier 111 is transmitted to the terminal device 1A, the terminal device 1A uses only the frequency bands 20 and 21. That is, the terminal device may use only a frequency band which can be controlled by the terminal device, in accordance with capability of the terminal device, among frequency bands indicated by combination identifiers. Regarding a frequency band of which a control is not possible, an instruction from the base station apparatus 3 may be ignored.

In a case where all frequency bands of the unlicensed band are used as the cell of the unlicensed band, the base station apparatus 3 notifies the terminal device 1 of information (referred to as first use information) indicating that all of the frequency bands are used. A combination identifier is used as the first use information, and thus a configuration or an instruction may be performed so as to perform a control (control of a first unlicensed band) in which the terminal device uses all of the frequency bands as the cell of the unlicensed band. In this example, 111 which is one of combination identifiers is assigned as information indicating that all of the frequency bands are used as the cell of the unlicensed band. However, dedicated information or a dedicated message which is information different from the combination identifier, and indicates a use of all of the frequency bands is separately prepared and used, and thus the terminal device may be notified to perform a control so as to use all of the frequency bands as the cell of the unlicensed band. That is, the dedicated information or the dedicated message may be provided as the first use information.

Conversely, in a case where a configuration or an instruction is performed so as to perform a control (control of a second unlicensed band) in which all of the frequency bands are in the unused state as the cell of the unlicensed band, the base station apparatus 3 notifies the terminal device 1 of information (referred to as second use information) indicating that not all of the frequency bands are used. As illustrated in FIG. 4, a notification of the combination identifier 000 as the second use information may be performed. In addition, instead of the combination identifier 000, dedicated information or a dedicated message which indicates unuse of all of the frequency bands is separately prepared and used. Thus, the terminal device may be notified to perform a control so as to be in a state where all of the frequency bands are unused as the cell of the unlicensed band. That is, the dedicated information or the dedicated message may be provided as the second use information. In this meaning, the dedicated information or the dedicated message may be referred to as information which does not indicate all frequency bands as a frequency band to be used as the cell of the unlicensed band, or as information which does not indicate all of frequency bands as the cell of the unlicensed band.

As will be described below, the dedicated information has an advantage that an instruction to control the first unlicensed band or to control the second unlicensed band can be performed with the information quantity smaller than that of the combination identifier. For example, in FIG. 4 or 5, the combination identifier has 3 bits. However, as will be described below, an instruction of a control of the first unlicensed band or a control of the second unlicensed band can be performed with 1 bit or 2 bits.

The dedicated information (dedicated message) is used along with information indicating a frequency band which is or is not used as the unlicensed band as represented by the combination identifier which is illustrated in FIGS. 4 and 5. Thus, a constitution in which an instruction of a control of a third unlicensed band, which is different from the control of the first unlicensed band and the control of the second unlicensed band is performed may be made (a concept in which no control relating to the cell of the unlicensed band is performed may be included as the control of the third unlicensed band). As the control of the third unlicensed band, a notification of the dedicated information (dedicated message) may be not performed, or the base station apparatus 3 may instruct the terminal device 1 by a notification of unlicensed-band control information other than the dedicated information (dedicated message) without the notification of the dedicated information (dedicated message).

For example, a notification of dedicated information (dedicated bit) which is constituted by at least one bit is performed from the base station apparatus 3 to the terminal device 1. The dedicated information may be transmitted to the terminal device 1 along with other control information by the base station apparatus 3, or may be independently transmitted to the terminal device 1 by the base station apparatus 3.

Firstly, here, a case where the dedicated bit is 1 bit will be described. When the dedicated bit is 1, the control of the first unlicensed band is performed. That is, all usable frequency bands are used as the cell of all unlicensed bands. When the dedicated bit is 0, the control of the second unlicensed band is performed. That is, using of the cell of all of the unlicensed bands which are being used is stopped (control in which all of the frequency bands are set to be unused, that is, no frequency band is used).

In a case where the dedicated bit is not transmitted, the control of the third unlicensed band is performed. That is, as illustrated in FIG. 4 or 5, when the combination identifier is separately used as the unlicensed-band control information, the control relating to the cell of an unlicensed band is performed in accordance with the received combination identifier. In a case where the unlicensed-band control information is not received, the control relating to a use start/stop of the unlicensed band is not performed.

The dedicated bit may be transmitted with being added to another piece of control information, or may be independently transmitted. The dedicated bit along with another piece of information required for controlling the cell of the unlicensed band may constitute another message, and the constituted message may be transmitted to the terminal device 1 from the base station apparatus 3.

The dedicated bit is not limited to 1 bit, and may be equal to or more than 2 bits. In a case where the dedicated bit is 2 bits, for example, a control as follows is possible. When the dedicated bit is 11, the control of the first unlicensed band is performed.

When the dedicated bit is 00, the control of the second unlicensed band is performed. In a case where the dedicated bit is not transmitted or in a case where the dedicated bit is 01 or 10, the control of the third unlicensed band is performed. In a case where the dedicated bit is not transmitted, the control relating to a use start/stop of the unlicensed band is not performed. When the dedicated bit is 01, a notification of another piece of unlicensed-band control information is indicated. A combination identifier included in the unlicensed-band control information in this case is defined so as to be in accordance with FIG. 4. When the dedicated bit is 10, a notification of another piece of unlicensed-band control information is also indicated. A combination identifier included in the unlicensed-band control information in this case is defined so as to be in accordance with FIG. 5. Here, a case using FIG. 4 is different from a case using FIG. 5, and it is assumed that using both of a DLCC and an ULCC in the cell of an unlicensed band to be used is indicated.

In a case where the dedicated bit is equal to or more than 2 bits, the dedicated bit may be also transmitted with being added to another piece of control information. The dedicated bit along with another piece of information required for controlling the cell of the unlicensed band may constitute another message, and the constituted message may be transmitted to the terminal device 1 from the base station apparatus 3.

A use in an instruction to control the third unlicensed band is not limited to a use of the combination identifier as illustrated in FIG. 4 or 5. A constitution of using the above-described frequency information may be made. For example, in this embodiment, in a case where frequencies of the frequency bands 15 to 17 which are the unlicensed band respectively correspond to F15, F16, and F17, if the frequency band 17 is used as the cell of the unlicensed band, a notification of control information may be performed with including information which indicates F17 which is the frequency information.

In a case where the frequency band 15 is added in a state of using the frequency band 17, the base station apparatus 3 may notify the terminal device 1 of F15 and F17 as the frequency information. Since the terminal device 1 currently uses the frequency band 17, it is understood that the frequency band 15 may be added, and a control is performed so as to use the frequency band 15 as the cell of the unlicensed band. In addition, a notification of only F15 as frequency information for a frequency band to be added may be performed, and thus an instruction to perform a control so as to use the frequency band 15 as the cell of the unlicensed band may be directly performed.

Conversely, for example, in a case where a change from a state of using the frequency bands 15 and 17 to a state where only the frequency band 15 is not used (the frequency band 17 is continuously used), the base station apparatus 3 may notify the terminal device 1 of F17. In this case, the terminal device 1 understands that only the frequency band 17 is used as the cell of the unlicensed band, understands that the frequency band 15 is not used, and performs a control so as to be in a state where the frequency band 15 is not used. In addition, a notification of F15 as information of a frequency band which is not used may be performed, and an instruction to perform a control so as to be in the unused state may be directly performed such that the frequency band 15 is not used as the cell of the unlicensed band.

In this manner, the base station apparatus 3 may perform a notification of only a frequency band which is to be controlled by the terminal device 1, and thus it may be possible to reduce the quantity of information of which a notification is performed.

When an instruction to control the second unlicensed band is performed, as described above, the dedicated information (dedicated message) is used. However, an instruction to control the second unlicensed band can be performed by using a mechanism for performing an instruction to control the third unlicensed band. Specifically, the dedicated information (dedicated message) is not transmitted, and a notification of the combination identifier 000 (or 111) in FIG. 4 or 5 is performed. Thus, the base station apparatus 3 can instruct the terminal device 1 to control the second unlicensed band (or to control the first unlicensed band).

Additionally, the dedicated information (dedicated message) is not transmitted, and a notification of frequency information of all usable frequency band as information of a frequency band which is not used, (in this example, F15, F16, and F17) is performed. Thus, an instruction to perform a control so as not to use the frequency bands 15, 16, and 17 as the cell of the unlicensed band may be directly performed. In the above descriptions, as described above, F15, F16, and F17 are used as information indicating a frequency. However, specifically, F15, F16, and F17 may correspond to pieces of information indicating frequencies, or pieces of information like indices indicating frequencies, as described above. If an index of a frequency band is known, the index of the frequency band along with the frequency information may be performed instead of the information indicating a frequency.

### Second Embodiment

The configuring method and the using method of the cell of the unlicensed band are described in the first embodiment. For example, a case where control information or unlicensed-band control information is used is described. In a second embodiment, a specific method of notifying a terminal of the control information or the unlicensed-band control information will be described.

As described above, the control information is generated by the radio resource control circuit portion 3011 of the base station apparatus 3, and the transmission circuit unit 307 notifies the terminal device 1 of the control information through the transmit and receive antenna 309. A notification of the control information may be performed in the cell 7 which is a primary cell, or the notification may be performed by the cell 5 which is a secondary cell. Particularly, in a case where any is not configured as the cell of the unlicensed band, and only the licensed band such as the cell 5 or 7 is used, the control information is transmitted in the cell 5 or the cell 7.

In a case where the cell of the unlicensed band has been already used, a terminal may be notified of the control information by using the cell of the unlicensed band. Conversely, even in a case where the cell of the unlicensed band is used, the cell of the unlicensed band is not used for a notification of the control information, and the terminal device 1 may be notified of the control information by using only the cell of the licensed band. Here, as a notifying method of control information applied to the cell of the unlicensed band, that is, the unlicensed-band control information to the terminal device 1, a first notifying method or a second notifying method may be selectively used or both of the first notifying method and the second notifying method may be used. In addition, only the first notifying method is defined so as to be used. In the first notifying method, a notification is performed by using the cell of the licensed band. In the second notifying method, a notification is performed by using a cell of the known unlicensed band. In a case where the cell of the unlicensed band is already used, a notification may be performed by using only the second notifying method.

When the terminal device 1 receives the control information including the unlicensed-band control information, in a case where the base station apparatus 3 uses the first notifying method, a first acquiring method of acquiring the control information including the unlicensed-band control information from only the licensed band is performed. In a case where the base station apparatus 3 uses the second notifying method, a second acquiring method of acquiring the control information from the cell of the unlicensed band is performed. In a case where the base station apparatus 3 uses the first notifying method and the second notifying method together, the terminal device 1 uses the first acquiring method and the second acquiring method together. In a case where the base station apparatus 3 uses only the first notifying method, only the first acquiring method may be performed.

FIG. 6 illustrates the second embodiment. A downward direction in FIG. 6 is defined so as to be a direction indicating a time lapse. The base station apparatus 3 notifies the terminal device 1 of the control information by using a DLCC 7 (corresponding to an arrow 63 in FIG. 6). In this embodiment, only the frequency band 17 is defined so as to be used as the cell of the unlicensed band. Thus, the control information is defined so as to include the combination identifier 010 as the unlicensed control information. If the terminal device 1 (reception circuit unit 105) receives the control information, the radio resource control circuit portion 1011 controls the frequency band 17 to be used as the cell of the unlicensed band, in accordance with the received control information (64 in FIG. 6).

The frequency band 17 is not used as the cell of the unlicensed band (17A in FIG. 6) up to the control, but the frequency band 17 is used as the unlicensed band by the control. In FIG. 6, 17B corresponds to this case. In FIG. 6, the control information (combination identifier 010) of the unlicensed band is acquired in a state where the frequency band 17 which is usable as the cell of the unlicensed band is not used as the cell of the unlicensed band. Thus, the frequency band 17 is started to be used as the cell of the unlicensed band (activated). The control information may be referred to as an instruction to activate the frequency band 17 as the cell of the unlicensed band, and the combination identifier 010 corresponds to an activation instruction. Originally, the frequency band 15 is not used as the cell of the unlicensed band, and thus the frequency band 15 is maintained. The terminal device 1 can also use the frequency band 16. However, here, particularly, no control is performed, and thus the frequency band 16 is not illustrated.

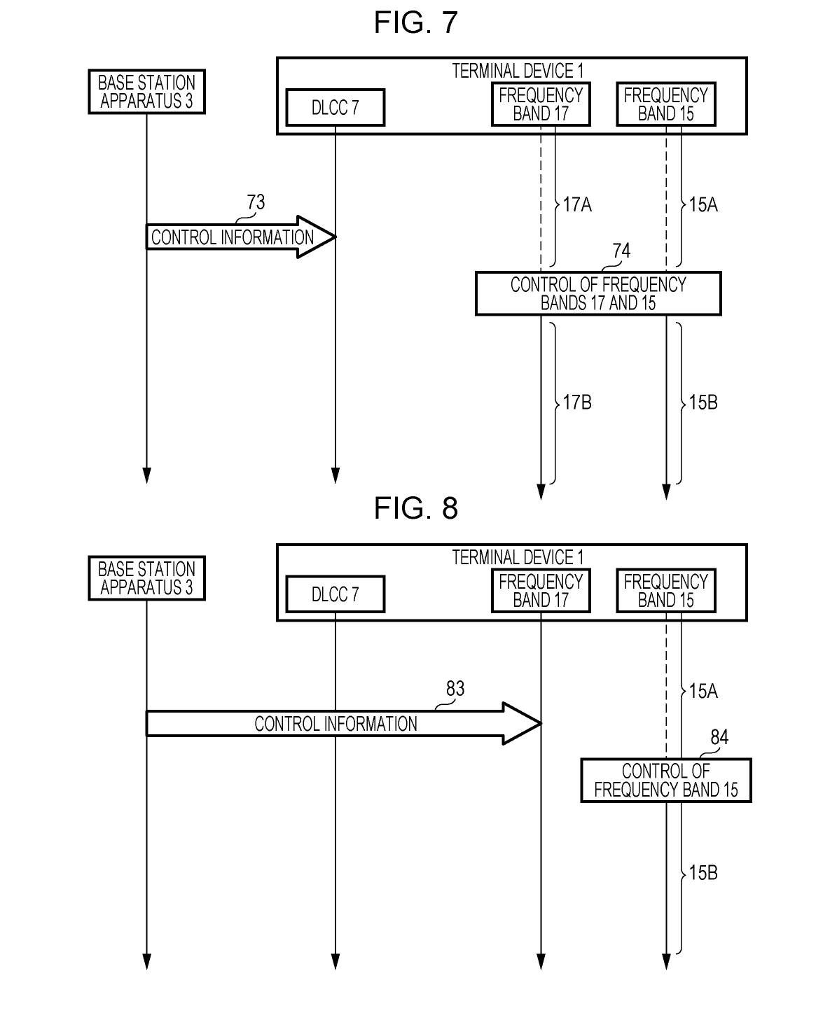

FIG. 7 illustrates another example in this embodiment. The base station apparatus 3 notifies the terminal device 1 of the control information by using the DLCC 7 (corresponding to an arrow 73 in FIG. 7). Here, in addition to the frequency band 17, the frequency band 15 is defined so as to be used as the cell of the unlicensed band. In this case, the control information includes the combination identifier 011 as the unlicensed control information. The terminal device 1 controls the frequency band 17 and the frequency band 15 to be used as the cell of the unlicensed band, in accordance with the control information (74 in FIG. 7). Until the terminal device 1 (reception circuit unit 105) receives the control information and the radio resource control circuit portion 1011 performs this control (74 in FIG. 7), the frequency bands 17 and 15 are not used as the cell of the unlicensed band (17A and 15A in FIG. 7). However, this control (after this control) causes the frequency bands 17 and 15 to be used as the unlicensed band. 17B and 18B in FIG. 7 correspond to this case. In FIG. 7, the control information (combination identifier 011) of the unlicensed band is acquired in a state where the frequency bands 15 and 17 which are usable as the cell of the unlicensed band are not used as the cell of the unlicensed band. Thus, the frequency bands 15 and 17 are started to be used as the cell of the unlicensed band (activated). The control information may be referred to as an instruction to activate the frequency bands 15 and 17 as the cell of the unlicensed band. The combination identifier 011 corresponds to the activation instruction. The terminal device 1 can also use the frequency band 16. However, here, particularly, no control is performed, and thus the frequency band 16 is not illustrated.

FIG. 8 illustrates another example in this embodiment. FIGS. 6 and 7 are the examples in a case where the cell of the unlicensed band is not configured or not used. Here, FIG. 8 illustrates a case where the cell of the known unlicensed band is used. For example, in FIG. 8, the frequency band 17 is used as the known unlicensed band. In such a state, the control information notifies the terminal device 1 by using a DLCC of the frequency band 17, not the DLCC 5 or the DLCC 7 which corresponds to the cell of the licensed band (corresponding to an arrow 83 in FIG. 8). Here, a case where the frequency band 15 is newly added as the cell of the unlicensed band will be described. In this case, the control information includes the combination identifier 011 as the unlicensed control information. Since the frequency band 17 is used as the cell of the known unlicensed band, if the terminal device 1 (reception circuit unit 105) receives the control information, the radio resource control circuit portion 1011 controls the frequency band 15 to be used as the cell of the unlicensed band, in accordance with the received control information (84 in FIG. 8). The frequency band 15 is not used as the cell of the unlicensed band (15A in FIG. 8) up to the control, but the frequency band 15 is used as the unlicensed band by the control. In FIG. 8, 15B corresponds to this case. In FIG. 8, the control information (combination identifier 011) of the unlicensed band is acquired in a state where the frequency band 15 which is usable as the cell of the unlicensed band is not used as the cell of the unlicensed band. Thus, the frequency band 15 is started to be used as the cell of the unlicensed band (activated). The control information may be referred to as an instruction to activate the frequency band 15 as the cell of the unlicensed band, and the combination identifier 011 corresponds to an activation instruction. The terminal device 1 can also use the frequency band 16. However, here, particularly, no control is performed, and thus the frequency band 16 is not illustrated.

In FIG. 8, a notification of the control information is performed by using the frequency band 17 which is used as the cell of the unlicensed band. However, for example, the notification of the control information may be performed by using the cell 7 or the cell 5 which is the cell of the licensed band, or by using both of the cell 7 and the cell 5.

In FIG. 6 or 7, the terminal device 1 is notified of the control information is performed by using the DLCC 7. However, the notification may be performed by using the DLCC 5 or by using both of the DLCC 5 and the DLCC 7. In FIGS. 6 to 8, a component carrier used in an information frequency band 17 and the frequency band 15 may be controlled so as to use an ULCC and a DLCC together. The component carrier may be controlled so as to use both of the DLCC and the ULCC or to use only the DLCC as illustrated in FIG. 5.

### Third Embodiment

The first notifying method and the second notifying method, and the first acquiring method and the second acquiring method which respectively correspond to the first notifying method and the second notifying method are described in the second embodiment. However, in this embodiment, a method in a case where information of which a notification is performed is unlicensed-band control information will be described.

The terminal device 1 may be notified of the unlicensed-band control information along with another piece of control information. The terminal device 1 is required to acquire unlicensed-band control information with being distinguished from another piece of control information, from information of which a notification is performed from the base station apparatus 3. In addition, when the information of which a notification is performed includes only the unlicensed-band control information, the terminal device 1 is required to recognize that the information of which a notification is performed includes only the unlicensed-band control information.

The terminal device 1 may be explicitly or implicitly notified of whether or not the information of which a notification is performed is the unlicensed-band control information, from the base station. For example, the base station apparatus 3 and the terminal device 1 share and use a format which is dedicatedly used for a notification of the unlicensed-band control information, and thus the base station apparatus 3 can easily notify the terminal device 1. For example, the terminal device 1 can easily determine that information of which a notification is performed at a point of time when the terminal device 1 detects that the used format is a dedicated format which is dedicatedly used for the unlicensed-band control information is unlicensed-band control information.

In addition, a method of using a dedicated identifier is provided. The terminal device 1 specifies whether or not control information detected when the terminal device 1 detects control information of the terminal device 1 is control information of the terminal device 1 obtained by blind decoding which uses a specific identifier (for example, C-RNTI, SPS C-RNTI, or other identifiers) from PDCCH candidates. Further, the terminal device 1 specifies whether or not control information specified when the control information of the terminal device 1 is specified is control information relating to a certain function.

For example, an unlicensed band C-RNTI (U C-RNTI) is an identifier (dedicated identifier) dedicated for unlicensed-band control information which is control information regarding the cell of an unlicensed band. The U C-RNTI is defined and used, and thus the base station apparatus 3 can notify the terminal device 1 of the control information regarding the cell of an unlicensed band.

Specifically, the base station apparatus 3 (radio resource control circuit portion 3011) assigns an U C-RNTI which is a dedicated identifier which is used in the unlicensed-band control information, to the terminal device 1. The base station apparatus 3 (radio resource control circuit portion 3011) assigns a PDCCH scrambled by using the U C-RNTI. As a DLCC on which the PDCCH is mapped, according to the second embodiment, the DLCC 7 which is a DLCC of a primary cell in a case of the first notifying method is assigned.

Here, the PDCCH may be allocated to the cell 5 which is a secondary cell. In a case where the cell of an unlicensed band is already used, the PDCCH may be allocated to any cell of the unlicensed band or to a plurality of cells of the unlicensed band.

That is, the base station apparatus 3 may notify the terminal device 1 of the unlicensed-band control information (may perform the first notifying method) by using at least one cell of the licensed band. In addition, the base station apparatus 3 may notify the terminal device 1 of the unlicensed-band control information (may perform the second notifying method) by using at least one cell of the unlicensed band.

The first notifying method and the second notifying method may be used together. For example, in a case where the frequency band 17 is configured as the cell of the unlicensed band according to the first embodiment, the PDCCH may be mapped on a DLCC of the frequency band 17 may be performed. Even in a case where the cell of the known unlicensed band is provided, the PDCCH may be mapped on the DLCC 7 by the first notifying method. In a case where, for example, the frequency band 17 is used as the cell of the unlicensed band, the PDCCH may be mapped on the DLCC of the frequency band 17. The PDCCH may be mapped by selectively using the first notifying method or the second notifying method or by using both of the first notifying method and the second notifying method.

A cell on which the information is mapped may be appropriately determined by, for example, the quantity of information of which a notification is performed by each cell. In addition, in a case where a cell in which the dedicated identifier can be used is specified or configured, assignment may be performed in accordance with the configuration.

The terminal device 1 (decoding circuit portion 1051) adds a PDCCH detected when the PDCCH is detected, to the specific identifier (for example, C-RNTI or SPS C-RNTI), and performs blind decoding of using the U C-RNTI. In a case where attempt of descrambling succeeds by the U C-RNTI, it is assumed that the unlicensed-band control information of the terminal device 1 is acquired. As described above, in a case where the base station apparatus 3 uses the first notifying method of using the DLCC 7, the terminal device 1 performs blind decoding on the DLCC 7, so as to perform the first acquiring method. In a case where the base station apparatus 3 uses the second notifying method, the terminal device 1 may perform the blind decoding on a DLCC of the cell of the known unlicensed band, so as to perform the second acquiring method.

In a case where the base station apparatus 3 uses the first notifying method, as described above, if the PDCCH is mapped on a DLCC of a secondary cell, not a DLCC of a primary cell, the terminal device 1 may perform the blind decoding for the secondary cell, so as to perform the first acquiring method. For example, the terminal device 1 may perform the blind decoding on the DLCC 5, and perform the blind decoding on the DLCC of the frequency band 17. Further, in a case where it is unclear whether the base station apparatus 3 uses the first notifying method or the second notifying method, the terminal device 1 may perform the blind decoding on the DLCC of the frequency band 17, in addition to the DLCC 7 and the DLCC 5, so as to perform both of the first acquiring method and the second acquiring method. That is, the first acquiring method and the second acquiring method may be selectively performed, or both of the methods may be performed.

In this embodiment, in the above descriptions, a case where the dedicated format or the dedicated identifier is used in order to notify the terminal device 1 that the control information is the unlicensed-band control information is described. Particularly, in the second notifying method in the second embodiment, the known method is used without using the dedicated format or the dedicated identifier, and thus the terminal device 1 can be notified that control information is the unlicensed-band control information.

For example, in a case where the base station apparatus 3 uses the second notifying method, that is, when the terminal device 1 is notified of the unlicensed-band control information by using the cell of the known unlicensed band, an identifier which is not used in the cell of the unlicensed band is intentionally used, and thus the terminal device 1 can be notified that control information is the unlicensed-band control information.

As described above, since the dedicated use of the unlicensed band is not permitted, using the unlicensed band in a communication for a long time by the base station apparatus 3 and the terminal device 1 is not possible. Thus, a function like semi-persistent scheduling on the assumption of a use for a long time is not appropriate as the function of the unlicensed band, and thus it is considered that the function like semi-persistent scheduling is better not to be used. Thus, the semi-persistent scheduling is set to not be used. In this case, the SPS C-RNTI may be set to not be used as an identifier in the unlicensed band. In this manner, an identifier which is not used is predetermined, and, for example, a notification of the unlicensed-band control information can be performed by intentionally using this identifier.

Thus, the terminal device 1 can perform determination as follows: in a case where the terminal device 1 is notified of the unlicensed-band control information by using the cell of the known unlicensed band, an SPS C-RNTI which is the not-used identifier is intentionally used, and a PDCCH which is scrambled by using the SPS C-RNTI and is allocated to the cell of the unlicensed band corresponds to the unlicensed-band control information, not to the control information of semi-persistent scheduling. That is, in the unlicensed band, the base station apparatus 3 transmits a PDCCH which has been scrambled by using an SPS C-RNTI, and the terminal device 1 performs blind decoding by using the SPS C-RNTI. Thus, a notification of the unlicensed-band control information can be performed.

Such an identifier is not limited to the SPS C-RNTI. For example, in a case where random access is not used in the unlicensed band, the identifier may be an RA C-RNTI which is allocated for the random access. In addition, in a case where a T C-RNTI is not used, the identifier may be the T C-RNTI. Anyway, the identifier may be a function, the specification, a mechanism, and the like which are not used in an unlicensed band which is used.

If the unlicensed-band control information is, for example, scheduling information for the cell of the unlicensed band, communication resource assignment performed by scheduling at this time is not semi-persistent scheduling, and is handled as timing scheduling by the terminal device 1. In this manner, a PDCCH transmitted in the unlicensed band is determined so as to be unlicensed-band cell control information, and thus defining a new U C-RNTI and performing a notification is not performed, and timing scheduling in the unlicensed band can be performed.

### Fourth Embodiment

In the second embodiment, a case where a frequency band of the unlicensed band is started to be used as the cell of the unlicensed band is described. However, in this embodiment, a case where the use as the cell of the unlicensed band is stopped will be described. Details and the meaning of information or a message which is transmitted from the base station apparatus 3 to the terminal device 1 when the base station apparatus 3 instructs the terminal device 1 to perform a control so as to cause the frequency band as the unlicensed band to not be used as the cell of the unlicensed band, that is, to be in the unuse state are already described in the first embodiment.

In this embodiment, descriptions will be made on the assumption that dedicated information (message) is used as information or an instruction which is transmitted from the base station apparatus 3 to the terminal device 1. That is, it is assumed that an instruction to control the second unlicensed band is performed by the dedicated information (message). The dedicated information which is used herein is defined so as to have 1 bit. However, it is not limited thereto, and as described in the first embodiment, the dedicated bit may be at least 1 bit. The instruction to control the second unlicensed band, which is performed by the dedicated bit is not limited thereto, and as described above, a notification of not using all frequency bands as the cell of the unlicensed band may be performed by using a notification (using 000 which is the combination identifier) or frequency information in FIG. 4 or 5.

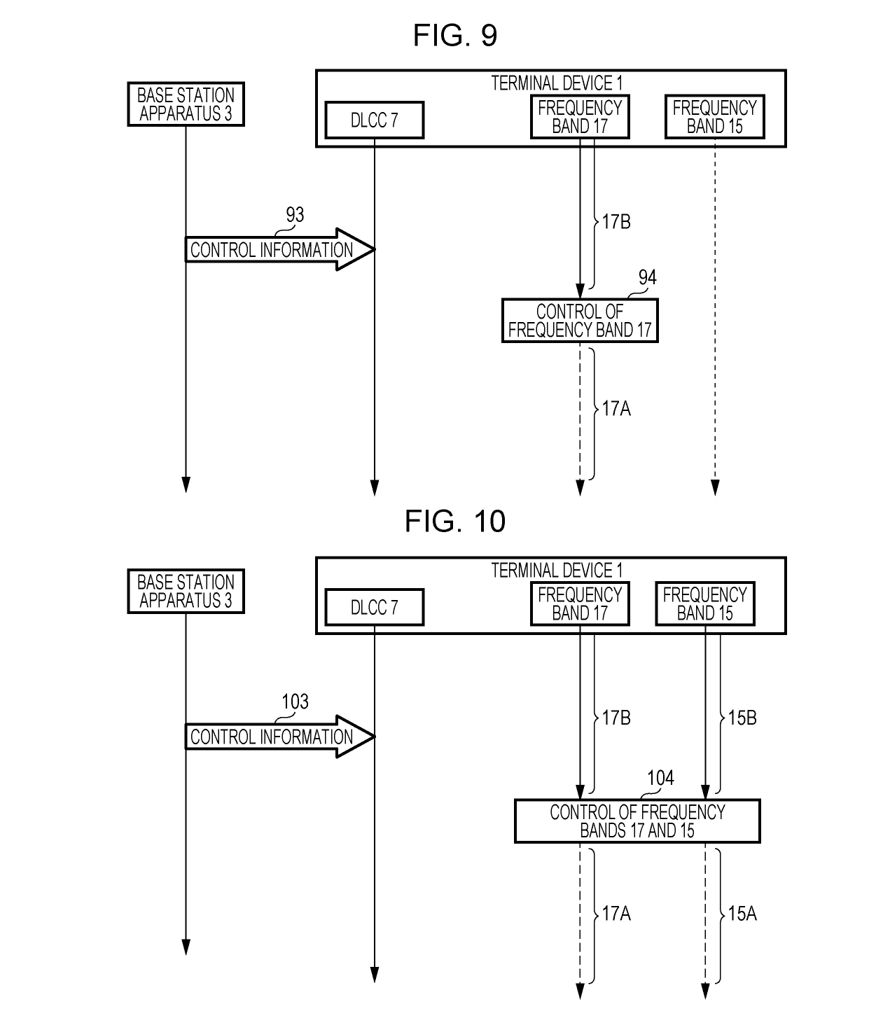

In FIG. 9, the base station apparatus 3 notifies the terminal device 1 of the control information by using the DLCC 7 of the cell 7 which is a primary cell (corresponding to an arrow 93 in FIG. 9). Here, only the frequency band 17 is used as the cell of the unlicensed band. The control information of which the dedicated bit is 0 is transmitted. If the terminal device 1 (reception circuit unit 105) receives the control information, the terminal device 1 controls the radio resource control circuit portion 1011 not to use cells of all frequency bands as the cell of the unlicensed band, in accordance with the control information. Here, the radio resource control circuit portion 1011 controls only the frequency band 17 not to be used as the cell of the unlicensed band due to the reason that a frequency band used as the unlicensed band is only the frequency band 17 (94 in FIG. 9). The frequency band 17 has been used as the cell of the unlicensed band before this control (17B in FIG. 9), but the frequency band 17 is not used as the unlicensed band by this control. 17A in FIG. 9 corresponds to this case. Originally, the frequency band 15 is not used as the cell of the unlicensed band, and thus the frequency band 15 is maintained. The terminal device 1 can also use the frequency band 16. However, here, particularly, no control is performed, and thus the frequency band 16 is not illustrated. The terminal device 1 is notified of the control information by using the cell 7. However, in a case where a secondary cell is used, the terminal device 1 may be notified by using only the secondary cell, by selectively using a primary cell or the secondary cell, or by using both of the primary cell and the secondary cell.

FIG. 10 illustrates another example in this embodiment. The base station apparatus 3 notifies the terminal device 1 of control information by using the DLCC 7 (corresponding to an arrow 103 in FIG. 10). Here, as described above, the frequency band 15 is also used as the cell of the unlicensed band, in addition to the frequency band 17. In this case, the control information includes a dedicated bit 0. If the terminal device 1 (reception circuit unit 105) receives the control information, the terminal device 1 controls the radio resource control circuit portion 1011 not to use the frequency band 17 and the frequency band 15 as the cell of the unlicensed band, in accordance with the received control information (104 in FIG. 10). The frequency bands 17 and 15 have been used as the cell of the unlicensed band before this control (17B and 15B in FIG. 10), but the frequency bands 17 and 15 are in a state of not being used as the unlicensed band by this control. 17A and 18A correspond to this case. The terminal device 1 can also use the frequency band 16. However, here, particularly, no control is performed, and thus the frequency band 16 is not illustrated. The terminal device 1 is notified of the control information by using the cell 7. However, in a case where a secondary cell is used, the terminal device 1 may be notified by using the secondary cell or by using both of the primary cell and the secondary cell. The terminal device 1 is notified of the control information by using the cell 7. However, in a case where a secondary cell is used, the terminal device 1 may be notified by using only the secondary cell, by selectively using a primary cell or the secondary cell, or by using both of the primary cell and the secondary cell.

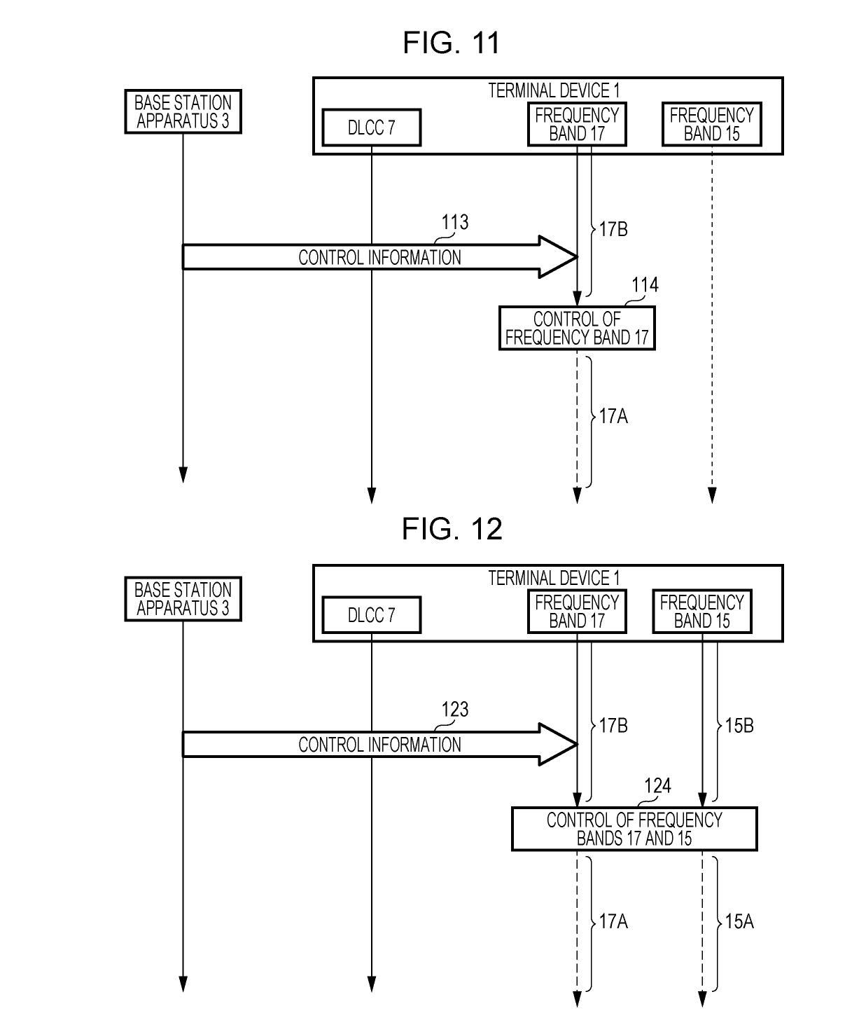

FIG. 11 illustrates still another example in this embodiment. FIGS. 9 and 10 illustrate a case where the DLCC 7 which corresponds to the cell of the licensed band is used. However, here, the terminal device 1 is notified by using the DLCC of the frequency band 17 which is already used as the cell of the unlicensed band (corresponding to an arrow 113 in FIG. 11). In this case, control information of which the terminal device 1 is notified includes the dedicated bit 0 as unlicensed control information. The frequency band 17 has been already used as the cell of the unlicensed band. However, the frequency band 15 is used as the cell of the unlicensed band. If the terminal device 1 (reception circuit unit 105) receives the control information, the terminal device 1 controls the radio resource control circuit portion 1011 not to use the frequency band 17 as the cell of the unlicensed band, in accordance with the received control information (114 in FIG. 11). The control is performed as follows: the frequency band 17 has been used as the cell of the unlicensed band up to this control (17B in FIG. 11), but the frequency band 17 is not used as the cell of the unlicensed band, by this control. 17A in FIG. 11 corresponds to this case. The terminal device 1 can also use the frequency band 16. However, here, particularly, no control is performed, and thus the frequency band 16 is not illustrated.

FIG. 12 illustrates still another example in this embodiment. Here, the frequency bands 15 and 17 which have been already used as the cell of the unlicensed band are used as the cell of the unlicensed band. The terminal device 1 is notified by using the DLCC of the frequency band 17 which has been used as the cell of the unlicensed band (corresponding to an arrow 123 in FIG. 12). In this case, the control information of which the terminal device 1 is notified includes the dedicated bit 0 as unlicensed control information. If the terminal device 1 (reception circuit unit 105) receives the control information, the terminal device 1 controls the radio resource control circuit portion 1011 not to use the frequency bands 15 and 17 as the cell of the unlicensed band, in accordance with the received control information (124 in FIG. 12). The control is performed as follows: the frequency bands 15 and 17 have been used as the cell of the unlicensed band up to this control (15B and 17B in FIG. 12), but the frequency bands 15 and 17 are not used as the cell of the unlicensed band, by this control. 15A and 17A in FIG. 12 correspond to this case. The terminal device 1 can also use the frequency band 16. However, here, particularly, no control is performed, and thus the frequency band 16 is not illustrated. The terminal device 1 is notified of the control information by using the frequency band 17. However, the terminal device 1 may be notified by using the frequency band 15 or by using both of the frequency bands 15 and 17. The terminal device 1 is notified of the control information by using the cell 7. However, in a case where the secondary cell is used, the terminal device 1 may be notified by using only the secondary cell, by selectively using a primary cell or the secondary cell, or by using both of the primary cell and the secondary cell.

### Fifth Embodiment

The examples are described regarding the configuring and controlling methods of the cell of the unlicensed band. However, in this embodiment, an operation of the terminal device 1 which uses the cell of the unlicensed band will be described. Here, the terminal device 1 is defined to use the cell 5 and the cell 7 as the cell of the licensed band, and to use the frequency bands 15, 16, and 17 which are all frequency bands which are usable as the cell of the unlicensed band. As illustrated in FIG. 1, it is assumed that an access point 11 is provided.

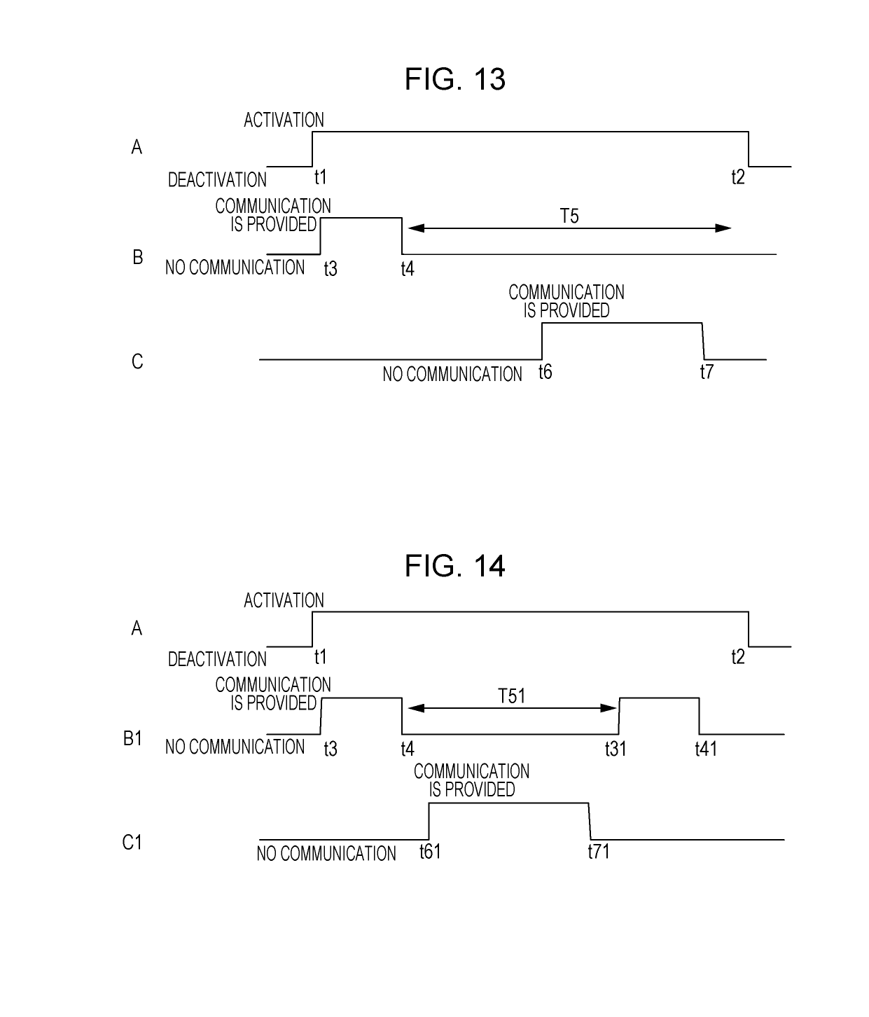

FIG. 13 is a transition diagram illustrating a state of the cell of each unlicensed band in this embodiment. In FIG. 13, a horizontal direction is defined so as to be a time direction, and representatively, the frequency band 15 is illustrated. A in FIG. 13 indicates a state as the cell of the unlicensed band. For example, it is assumed that the frequency band 15 is started to be used as the cell of the unlicensed band at a point of time t1, and the frequency band 15 is controlled so as to be in a state of not being used as the cell of the unlicensed band at a point of time t2. Here, a first state in which activation is performed, a first activated state, or first activation is described as a state of being used as the cell of the unlicensed band. A start of using as the cell of the unlicensed band is referred to as performing first activation. In the following descriptions, as long as particular statements or limitations are not provided, “the first” will be omitted from “the first activation”, and “the first activation” is referred to as the state in which activation is performed, the activated state, activation, or performing activation.

The state of not being used as the cell of the unlicensed band is described as a first state in which deactivation is performed, a first deactivated state, or simply first deactivation. A stop of using as the cell of the unlicensed band is referred to as performing first deactivation. In the following descriptions, as long as particular statements or limitations are not provided, “the first” will be omitted from “the first deactivation”, and “the first deactivation” is referred to as the state in which deactivation is performed, the deactivated state, deactivation, or performing deactivation.

B in FIG. 13 indicates whether, actually, communication resources for user data transmission are assigned by the base station apparatus 3, and are used in a communication (communication status). As indicated by B in FIG. 13, radio resources are scheduled, and a communication is actually started at a point of time t3, and the communication is ended at a point of time t4 (below, as described above, the communication with the base station apparatus 3, which uses the cell of the unlicensed band is defined so as to be a first communication).

The frequency band 15 is in a state of being still activated as the cell of the unlicensed band even after t4. Thus, in a time region T5, since the frequency band 15 is activated, the frequency band 15 is in a state of being capable of being used in a communication at any time, and is in a state of not currently being used. In other words, in the time region T5, the frequency band 15 is in a state where the frequency band 15 is activated as the cell of the unlicensed band, but a portion thereof is not assigned as a communication resource.

Thus, the terminal device 1 does not use the frequency band 15 as the cell of the unlicensed band in the time region T5. The terminal device 1 can start a communication with another device, for example, such as the access point 11, or another personal computer or printer (not illustrated), in accordance with another specification, for example, in accordance with 802.11n (below, as described above, a communication different from the first communication is defined so as to be second communication). It is assumed that a communication is started in accordance with 802.11n in a point of time t6 in FIG. 13, and the communication is ended in accordance with 802.11n, at a point of time t7.

FIG. 14 illustrates still another example. Similarly in FIG. 13, A in FIG. 14 indicates whether or not the frequency band 15 is used as the unlicensed band, that is, whether or not the frequency band 15 is activated. B1 indicates whether or not the frequency band 15 is used as the cell of the unlicensed band (whether or not the terminal device 1 communicates with the base station apparatus 3 by using the frequency band 15). C1 indicates whether or not the frequency band 15 is used as 802.11n.

In B1, in a time region T51, the frequency band 15 is not used in the communication regardless of the frequency band 15 being activated as the cell of the unlicensed band. Thus, as indicated by C1, the terminal device 1 communicates with another device, for example, such as the access point 11, a personal computer, and a printer, in accordance with 802.11n, in a period from a point of time t61 to a point of time t71.

In FIG. 13 or 14, a constitution in which the base station apparatus 3 is notified to start a communication which is different from the communication as the cell of the unlicensed band (for example, using the cell 7 or the cell 5 which is the cell of the licensed band) may be made. A constitution in which the base station is notified to end a communication when the communication other than the communication as the cell of the unlicensed band is ended may be made.

In the communication as illustrated in FIG. 13 or 14, if the terminal device 1 easily start the second communication, the appropriate start of the first communication when the base station apparatus 3 starts to perform the first communication may be not possible. Thus, the base station apparatus 3 can notify the terminal device 1 of information indicating whether or not the second communication is possible. The terminal device 1 can acquire the information from the base station apparatus 3, and can determine whether or not the second communication can be started, in accordance with the acquired information. The second communication is started or the second communication is not started, in accordance with this determination.

For example, in a case where information (information for permitting the second communication) indicating that the second communication is explicitly permitted from the base station apparatus 3 is acquired, the terminal device 1 starts the second communication, if necessary. In a case where the terminal device 1 determines that the second communication is required, or in a case where the terminal device 1 determines that the second communication is not required, even when any piece of information for permitting the second communication is acquired from the base station apparatus 3, the second communication is not performed.

Conversely, even in a case where the terminal determines that the second communication is required, if the information for permitting the second communication is not acquired from the base station apparatus 3, the second communication is not started. Similarly, instead of the case where the base station apparatus 3 does not notify the terminal device 1 of the information for permitting the second communication, in a case where information for prohibiting the second communication is acquired, the terminal device 1 does not start the second communication.

Conversely, a constitution as follows may be made: in a case where the base station apparatus 3 does not notify the terminal device 1 of the information for prohibiting (not permitting) the second communication, and the terminal does not acquire the information for prohibiting the second communication, from the base station apparatus 3, if the terminal device 1 determines that the second communication is required, the terminal device 1 starts the second communication in accordance with the determination.

That is, at least one or both of the information for permitting the second communication and the information for prohibiting the second communication can cause the base station apparatus 3 to notify the terminal device 1 to permit or prohibit the second communication. Thus, the terminal device 1 can determine whether the second communication is permitted or prohibited.

Information used in determination of whether or not the second communication may be started may be information which is directly indicated in this manner. However, the base station apparatus 3 may indirectly instruct the terminal device 1. The instruction is performed, for example, by using the information which is used in the determination of whether or not the second communication is enabled to be started. As an example of the information used in the determination of whether or not the second communication is enabled to be started, information which indicates threshold, and is information of which the terminal device 1 is notified from the base station apparatus 3 can be used. The notification of the threshold may be individually performed to each terminal device. For example, the terminal device may be individually notified of the threshold with being included in the unlicensed-band control information. The terminal device may be individually notified of the threshold with being included in broadcast information. In a case where, for example, a certain threshold corresponds to the information of which the terminal device 1 is notified from the base station apparatus 3, and the certain threshold is common in the system, and is not changed, the notification is not required.

The terminal device 1 compares the threshold with the total accumulated amount of communication resources assigned to at least one or both of the cell of the unlicensed band and the cell of the licensed band, or with the amount of communication resources in a unit time. In a case where the amount of the communication resources is less than the threshold or more than the threshold, it may be determined that a probability of assigning resources to the cell of the unlicensed band is small or large. Thus, it may be determined that the second communication is possible or impossible.

Here, in order to determine whether or not the second communication is possible, the terminal device 1 uses the assigned communication resources. However, it is not limited thereto, and the terminal device 1 may use another piece of control information or use both of the communication resources and the other piece of control information. As the other piece of control information, for example, a modulation scheme, transmitted power of the terminal device 1, communication quality, throughput, or the like may be used. However, it is not limited thereto. In a case where such control information is used, the threshold as described above may be not one or may have a plurality of values.

The terminal device 1 may independently perform the determination without acquiring the information which is used in the determination of whether or not the second communication is enabled to be started, from the base station apparatus 3. For example, the terminal device 1 may independently perform the determination by using the assigned communication resource, a modulation scheme, transmitted power, communication quality, or throughput, as described above.

In this embodiment, an uplink and a downlink are not distinguished from each other, in a communication between the base station apparatus 3 and the terminal device 1. That is, descriptions will be made on the assumption that an uplink communication and a downlink communication are performed together. This example is not limited thereto. For example, the frequency band as described above may be defined so as to be constituted by only a downlink, that is, only a DLCC.

In the above descriptions, when the terminal device 1 starts the second communication, the terminal device 1 performs determinations twice. Firstly, the terminal device 1 determines whether or not the second communication is enabled to be started (first determination), and determines whether or not the second communication is actually performed (second determination). In other words, determination which is performed based on information from the base station apparatus 3, and is for whether or not the second communication is possible may be defined so as to be the first determination. Determination of whether or not the second communication is performed regardless of an instruction received from the base station apparatus 3 by the terminal device 1 may be defined so as to be the second determination. As in the above example, the second determination may be performed after the first determination. In addition, as in an example which will be described next, the second communication may be performed based on only the second determination.

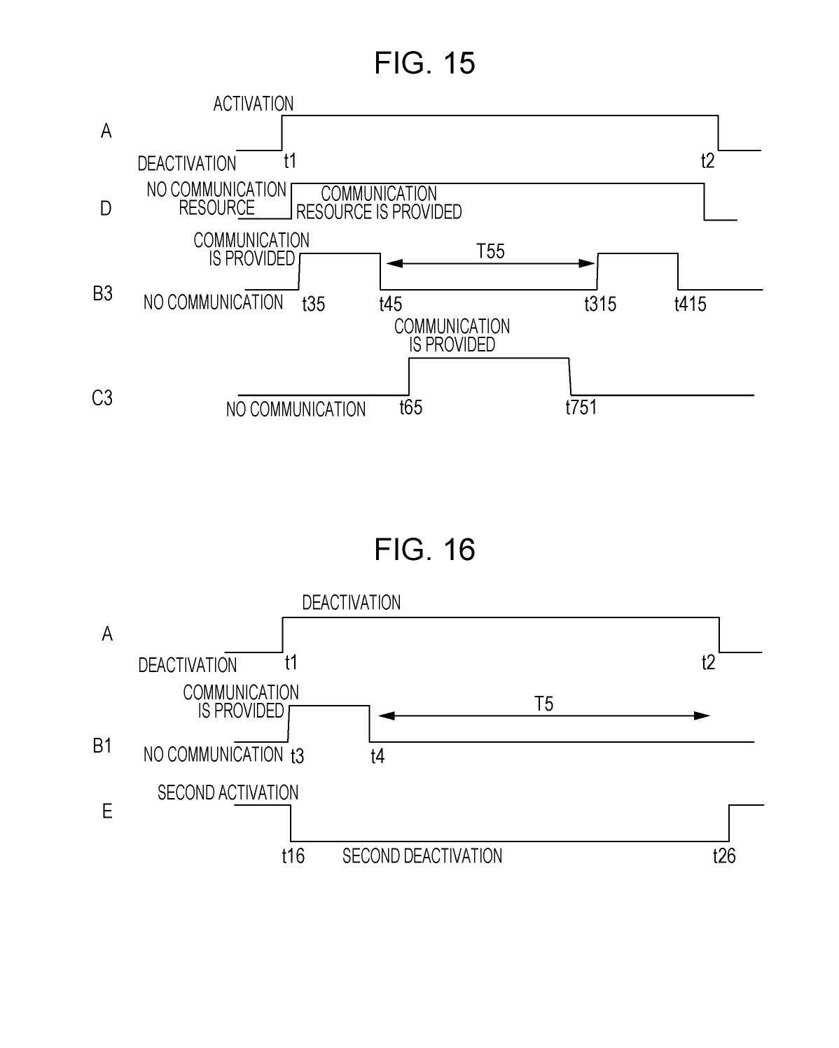

FIG. 15 illustrates another example. In this embodiment, similarly to the above-described drawings, A indicates whether or not the frequency band as the cell of the unlicensed band is activated. D indicates whether or not a communication resource is assigned to the activated frequency band. B3 indicates whether or not the terminal device 1 actually performs the first communication with the base station apparatus 3 by using the assigned communication resource. C3 indicates whether or not the second communication is performed. In FIG. 15, regardless of assignment of a communication resource, as indicated by D, a time region T55 in which the first communication using the communication resource is not performed is provided. In the time region T55, originally, a communication resource is assigned. Thus, the second communication is intentionally performed at a time when the first communication is originally to be performed. This point is largely different from the case of FIG. 14.

In the example in FIG. 15, it is common that the terminal device 1 performs the first communication with the base station apparatus 3 by using a communication resource during a period when, originally, the communication resource is assigned. However, the terminal device 1 independently stops the communication with the base station apparatus 3 (t45), and starts the second communication instead (T65). The second communication may be, for example, another terminal device (not illustrated) or a printer (not illustrated). Particularly, it is not limited thereto. After the second communication is started, the second communication is ended at t751. After the second communication, the terminal device 1 starts the first communication with the base station apparatus 3, again (t315). Data to be transmitted by the terminal device 1 at T55 may be transmitted to the base station by, for example, using another frequency band which is used as the cell of the unlicensed band. The data may be transmitted to the base station by using the cell of the licensed band. In addition, the data may be transmitted to the end by using only the frequency band 15.

In the above drawings, the descriptions are made focused on the use example of the frequency band 15 which is used as the cell of the unlicensed band (using for communicating with the base station apparatus 3). However, for simple descriptions, a portion of descriptions for a case of using the frequency band 15 as the unlicensed band, for example, a case of communicating with another device in accordance with the specification of 802.11n is omitted. Thus, using the frequency band 15 which is the unlicensed band will be described in more detail.

FIG. 16 illustrates a use of the frequency band 15 of the unlicensed band in FIG. 13 (for example, communication with another device in accordance with the specification of 802.11n). A or B1 is similar to that in FIG. 13, and thus descriptions thereof will be omitted. E in FIG. 16 indicates whether or not the terminal device 1 can use the frequency band 15 as the frequency band of the unlicensed band, in accordance with, for example, the specification of 802.11n. The frequency band 15 is assumed to be controlled so as to be used as the unlicensed band (for example, to be in a state of being enabled to be used in a communication in accordance with the specification of 802.11n) until a point of time t16, and so as to be in the unused state as the cell of the unlicensed band (for example, to be in a state where the communication in accordance with the specification of 802.11n is not enabled) at a point of time t26. Here, the state of being enabled to be used as the unlicensed band (communication in accordance with the specification of 802.11n) is described as a second state in which activation is performed, a second activated state, or second activation. A start of using as the unlicensed band (for example, using in the communication in accordance with the specification of 802.11n) (defined so as to be a second activated state) is referred to as performing the second activation. Further, the state where using as the unlicensed band (for example, using in the communication in accordance with the specification of 802.11n) is not possible is described as a second state in which deactivation is performed, a second deactivated state, or simply second deactivation. Similarly, being in a state where the frequency band 15 is not used as the unlicensed band (for example, the frequency band 15 is not used in the communication in accordance with the specification of 802.11n) is referred to as the second deactivation. That is, in FIG. 16, the frequency band 15 is in the first deactivated state until a point of time t1, and is in the second activated state until a point of time t16. The frequency band 15 is controlled so as to be in the first activated state at the point of time t1, and to be in the second deactivated state at the point of time t16 (subjected to the first activation and the second deactivation). Similarly, the frequency band 15 is controlled so as to be in the first deactivated state at a point of time t2, and to be in the second activated state at a point of time t26 (subjected to the first deactivation and the second activation). That is, E indicates the second activation or the second deactivation. Here, t1 and t16 may be points of time different from each other (t1≠t16), or may be the same point of time (t1=t16). Similarly, t2 and t26 may be points of time different from each other (t2≠t26), or may be the same point of time (t2=t26). In a case where simultaneous control is difficult, t1 and t16 or t2 and t26 may be points of time different from each other. At this time, if t1<t16 at this time, that is, since the first activation is performed, and then the second deactivation is performed, during a period from t1 to t16, the frequency band is in the second activated state while being in the first activated state. In a case where this control has a problem, t1>t16 may be satisfied, and the second deactivation may be performed, and then the first activation may be performed. Similarly, regarding t2 and t26, a constitution in which t2<t26 is satisfied, and the first deactivation is performed, and then the second activation is performed may be made.

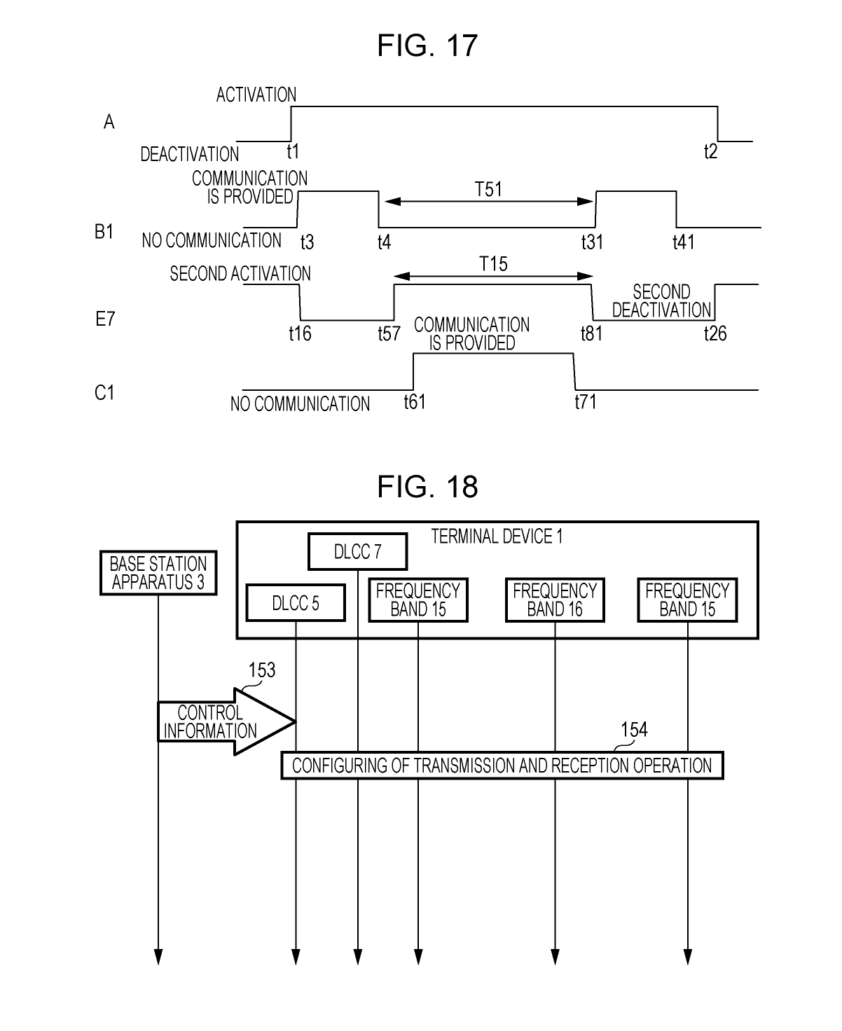

FIG. 17 illustrates another example. FIG. 17 is used for describing the second activation and the second deactivation of the frequency band 15 in FIG. 14. Since A, B1, and C1 in FIG. 17 are the same as those in FIG. 14, descriptions thereof will be omitted. E7 in FIG. 17 indicates the second activation or the second deactivation, and indicates whether or not the terminal device 1 can use the frequency band 15 as the frequency band of the unlicensed band, for example, in accordance with the specification of 802.11n. Similarly to in FIG. 16, the frequency band 15 is controlled so as to be in the first deactivated state until a point of time t1, and be in the second activated state until a point of time t16. The frequency band 15 is controlled so as to be in the first activated state at the point of time t1 and to be in the second deactivated state at the point of time t16.

Similarly, a control is performed so as to be in the first deactivated state at a point of time t2, and to be in the second activated state at a point of time t26. In FIG. 17, if the terminal device 1 determines that the communication with the base station apparatus 3 is not performed by using the frequency band 15 as the cell of the unlicensed band in a time region T15, the terminal device 1 causes the frequency band 15 to be in the second activated state.

As the determination, various other determinations are possible. However, here, it is assumed that the terminal device 1 performs the determination by using throughput (or communication quality). For example, it is assumed that, originally, the terminal device 1 obtains good throughput by the first communication just after t3, for example. However, in a case where the throughput (or communication quality) is degraded just before t4, switching to the second communication can be performed. Even when the communication is in the process of being performed by the second communication, if the throughput (communication quality) in the first communication is improved, switching to the first communication may be performed.

A communication destination of the second communication may be the base station apparatus 3, or may be another device, for example, a printer or another terminal device. In a case where the terminal device 1 determines that a communication with another device by the second communication is required, during the first communication, the terminal device 1 may suspend the first communication and perform the second communication with another device other than the base station apparatus 3.

In addition, even in a case where the base station apparatus 3 activates the frequency band of the unlicensed band, for example, activates the frequency band 15 as the cell of the unlicensed band, or even in a case where a communication resource for the first communication is assigned to the terminal device 1, the terminal device 1 does not perform the first communication, and performs determination so as to perform the second communication. Thus, the terminal device 1 may perform a control to perform second communication. Such a control is effective, for example, in a case where the communication expense of the communication with the base station apparatus 3 is expensive, or in a case where an amount of consumed power is large.

Conversely, for example, in a case where the communication expense of the communication with the base station apparatus 3 is cheap, or in a case where an amount of consumed power is small, the control may be performed so as not to perform the second communication, and to perform only the first communication as the communication with the base station apparatus 3.

In FIG. 17, the second activation is performed at t57, and then the second communication is started at t61. Then, if the second communication is ended, the terminal device 1 starts the first communication again as the second deactivation at a point of time t81. The first communication is started ahead of t31. Then, as described above, a control is performed so as to be in the first deactivated state at t2, and a control is performed so as to be in the second activated state at t26. Such a control, that is, a point that, regardless of being in the first activated state, the second activation is started, and the second communication is started in the first activated state and the second activated state, and a point that, after the second communication, the second deactivation is performed so as to return to a state of only the first activated state is not limited to FIG. 14, and can be also applied to FIGS. 13 and 15. Such the control may be limited to a case where, even though the terminal device 1 is in the first activated state and is also in the second activated state, the terminal device 1 has no problem.

The information used in the determination of whether or not the second communication is enabled to be started may be, for example, information as follows. The information indicates, for example, whether scheduling information for the cell of the unlicensed band is acquired via the licensed band, or is acquired in the licensed band. In other words, the base station apparatus 3 can notify the terminal device 1 of whether or not the second communication is possible, based on whether or not the base station apparatus 3 notifies the terminal device 1 of the scheduling information via the licensed band or via the unlicensed band.

For example, a communication is started at t3, based on the scheduling information received from the base station apparatus 3. Here, in a case where a notification of the scheduling information is performed by using, for example, the cell of the licensed band, if scheduling information for the frequency band 15 which corresponds to the cell of the unlicensed band is not provided, for example, as at the time region T51, it is determined that the second activation or the second communication is possible, as illustrated in FIG. 17. A communication based on the scheduling information received from the base station apparatus 3 is started at t3. Here, in a case where a notification of the scheduling information is performed by using, for example, the cell of the unlicensed band, if scheduling information for the frequency band 15 which corresponds to the cell of the unlicensed band is not provided, as at the time region T51, it is determined that the second activation or the second communication is possible, as illustrated in FIG. 17.

Conversely, in a case where the first communication is started based on the scheduling information received from the base station apparatus 3 in FIG. 17, and a notification of the scheduling information is performed by using, for example, the cell of the licensed band, if scheduling information for the frequency band 15 which corresponds to the cell of the unlicensed band is not provided, for example, as at the time region T51, it is determined that the second activation or the second communication is not possible, as illustrated in FIG. 17. In a case where the communication based on the scheduling information received from the base station apparatus 3 is started at t3, here, a notification of the scheduling information is performed by using, for example, the cell of the unlicensed band, if scheduling information for the frequency band 15 which corresponds to the cell of the unlicensed band is not provided, for example, as at the time region T51, it is determined that the second activation or the second communication is possible, as illustrated in FIG. 17.

That is, the base station apparatus 3 can notify the terminal device 1 of whether or not the second communication is possible, based on whether a notification of the scheduling information for the cell of the unlicensed band (for a frequency band used as the cell of the unlicensed band) is performed by using the cell of the licensed band or the cell of the unlicensed band. The terminal device 1 can recognize the above-described point.

In the above descriptions, an example of the scheduling information as the control information of the unlicensed band is described. However, it is not limited thereto, and the scheduling information may be another piece of the control information. For example, determination may be performed based on whether or not an activation instruction of the unlicensed band uses the licensed band.

For example, in a case where activation of the frequency band as the cell of the unlicensed band is performed by using the cell of the known unlicensed band (in a case where the terminal device 1 receives an instruction of activating the cell of another unlicensed band by using the cell of the unlicensed band), the terminal device 1 determines that the second communication is possible or is permitted.

In a case where the frequency band as the cell of the unlicensed band is activated by using the cell of the licensed band (in a case where the terminal device 1 receives an instruction of activating the cell of another unlicensed band by using the cell of the licensed band), the terminal device 1 determines that the second communication is not permitted.

In other words, in a case where the cell of the unlicensed band is activated by using the cell of the unlicensed band, the terminal device 1 determines that the second communication is permitted. In a case where the cell of the unlicensed band is activated by using the cell of the licensed band, the terminal device 1 determines that the second communication is not permitted.

Conversely, in a case where the frequency band as the cell of the unlicensed band is activated by using the cell of the known unlicensed band (in a case where the terminal device 1 receives an instruction of activating the cell of another unlicensed band by using the cell of the unlicensed band), the terminal device 1 determines that the second communication is not permitted.

In a case where the frequency band as the cell of the unlicensed band is activated by using the cell of the licensed band (in a case where the terminal device 1 receives an instruction of activating the cell of another unlicensed band by using the cell of the licensed band), the terminal device 1 determines that the second communication is permitted.

In other words, in a case where the cell of the unlicensed band is activated by using the cell of the licensed band, the terminal device 1 determines that the second communication is permitted. In a case where the cell of the unlicensed band is activated by using the cell of the unlicensed band, the terminal device 1 determines that the second communication is not permitted.

Such the determination of whether or not the second communication is permitted may be applied to only one cell of the unlicensed band, or may be also applied to another cell. Here, it is assumed that the unlicensed band 15 is already activated. If the frequency band as the cell of the unlicensed band is activated by using the cell of the unlicensed band, the second communication is assumed to be permitted. If the frequency band is activated by using the cell of the licensed band, the second communication is assumed not to be permitted.

For example, in a case where, for example, the frequency band 16 is activated by using the frequency band 15 which is used as the cell of the unlicensed band, it may be determined that the second communication is permitted only in the frequency band 16. However, it may be determined that the second communication is permitted in all frequency bands (frequency bands 15 and 16) which are used.

In a case where, for example, the frequency band 16 is activated by using a cell (for example, cell 5) which is used as the cell of the licensed band, it may be determined that the second communication is not permitted only in the frequency band 16. However, it may be determined that the second communication is not permitted in all frequency bands (frequency bands 15 and 16) which are used.

The above descriptions focus on only determination of whether a notification of control information like licensed-band control information is performed in the licensed band or in the unlicensed band. In the following example, a method in which the base station apparatus 3 notifies the terminal device 1 will be described. The notification is for determining whether or not the second communication is permitted, and for determining a frequency band or a cell which is used in the notification of the control information.

As described above, focusing on a frequency band or a cell which is used when a notification of the scheduling information for the frequency band 15 is performed, in a state where the frequency band 15 is used as the cell of the unlicensed band is performed.

A case where the notification of the scheduling information for the frequency band 15 is performed by using a frequency band other than the frequency band 15 indicates that the second communication is permitted. A case where the notification is performed by using the frequency band 15 indicates that the second communication is not permitted. Here, the frequency band other than the frequency band 15 may be, for example, the cell 5 or the cell 7 of the licensed band. In a case where the frequency band other than the frequency band 15 is already used as the cell of another unlicensed band (for example, the frequency band 16 or 17 is already used), the frequency band other than the frequency band 15 may be the frequency band 16 or 17.

Conversely, a case where the notification of the scheduling information for the frequency band 15 is not performed by using the frequency band other than the frequency band 15 indicates that the second communication is not permitted. A case where notification is performed by using the frequency band 15 indicates that the second communication is permitted. Here, the frequency band other than the frequency band 15 may be, for example, the cell 5 or the cell 7 of the licensed band. In a case where the frequency band other than the frequency band 15 is already used as the cell of another unlicensed band (for example, the frequency band 16 or 17 is already used), the frequency band other than the frequency band 15 may be the frequency band 16 or 17.

### Sixth Embodiment

In each of the examples, information which is used as the unlicensed-band control information included in control information is included. The included information indicates that the frequency band of the unlicensed band is used or is not used as the cell of the unlicensed band or the included information is used in determination of whether or not the second communication may be started as described above. In this embodiment, a case of including another piece of information, for example, scheduling information, as the unlicensed-band control information will be described.

For example, the case in FIG. 1 will be described. In FIG. 1, the cells 5 and 7 are used as the cell of the licensed band. In this state, it is assumed that the terminal device 1 stops a communication with a device other than the base station apparatus 3, which is performed by using the frequency band of the unlicensed band as the cell of the unlicensed band, and the terminal device 1 communicates with the base station apparatus 3 by using the frequency band of the unlicensed band as the cell of the unlicensed band. With this constitution, as a method in which a notification of scheduling information for the cell of the licensed band is performed from the base station apparatus 3 to the terminal device 1, four methods are roughly provided.

A first scheduling information notifying method is a method in which a notification of the scheduling information for the cell of the licensed band is performed by using the cell of the licensed band. For example, a notification of scheduling information for the cell 5 may be performed by using the cell 5, or may be performed by using a cell which is different from the cell 5, here, the cell 7. That is, in the first scheduling information notifying method, a notification of scheduling information for at least one of licensed bands is performed by using the cell of at least one of the licensed bands.

A second scheduling information notifying method is defined so as to be a method in which a notification of scheduling information for the cell of the licensed band which is the cell 5 or the cell 7 is performed by using a frequency band which is used as the cell of the unlicensed band. In the second scheduling information notifying method, the cell of an unlicensed band corresponding to a frequency band which is used for transmitting the scheduling information for the cell of the licensed band is not particularly limited, and cell of a licensed band of which a notification is performed by using the cell of the unlicensed band is not particularly limited. The second scheduling information notifying method focuses on a notification of the scheduling information for the cell of the licensed band, which is performed by using the cell of the unlicensed band. That is, in the second scheduling information notifying method, the notification of scheduling information for at least one of licensed bands is performed by using a frequency band which is used as the cell of at least one of unlicensed bands.

A notification of scheduling information for the cell of the unlicensed band can be performed by using the cell of the licensed band. This case is defined so as to be a third scheduling information notifying method. Here, a relation between the cell of the licensed band for a notification of the scheduling information, and the unlicensed band in which the notification is performed is not particularly limited. For example, a notification of scheduling information for the frequency band 15 which corresponds to the cell of the unlicensed band may be performed by using the cell 7 which is the cell of the licensed band. A notification of scheduling information for the frequency band 16 may be performed, and a notification of scheduling information for the frequency band 17 may be performed.

A notification of scheduling for a frequency band which is used as the cell of a plurality of unlicensed bands may be performed by using a cell of one licensed band, or by using cells of a plurality of licensed bands. For example, a notification of scheduling information for the frequency bands 15, 16, and 17 which are used as the unlicensed bands may be performed by using the cell 5 and the cell 7. That is, in the third scheduling information notifying method, a notification of scheduling information for a frequency band which is used as the cell of at least one of unlicensed bands is performed by using the cell of at least one of licensed bands.

A method in which the cell of the unlicensed band is used for scheduling information for the cell of the unlicensed band is defined so as to be a fourth notifying method for scheduling information. Here, for example, a notification of scheduling information for the frequency band 17 may be performed by using the frequency band 17, that is, the notification may be performed by using the frequency band itself, or by using a cell of another unlicensed band.

For example, a notification of scheduling information for the frequency band 16 may be performed by using the frequency band 15. Additionally, the frequency band 15 may be used for a notification of scheduling information for the frequency band 15 and scheduling information for the frequency band 16. The frequency band 16 may be used for a notification of scheduling information for the frequency band 17. A notification of scheduling information for all frequency bands may be performed by using one frequency band. That is, in the fourth scheduling information notifying method, a notification of scheduling information for a frequency band used as the cell of at least one of unlicensed bands may be performed by using a frequency band which is used as the cell of at least one of the unlicensed bands. Each of the above-described scheduling information notifying methods may be singly performed, or may be performed in combination of the methods.

FIG. 18 illustrates one example. FIG. 18 illustrates a case where the third scheduling information notifying method is performed along with the first scheduling information notifying method. Here, control information of the licensed band, which includes scheduling information assigned to the cell of the licensed band, and unlicensed-band control information which includes scheduling information assigned to the cell of the unlicensed band are included in one piece of control information, and the base station apparatus 3 notifies the terminal device 1 of the one piece of control information.

The licensed-band control information and the unlicensed-band control information may be included in one piece of control information, and a notification of the one piece of control information may be performed at once. The licensed-band control information and the unlicensed-band control information may be respectively included in pieces of control information, and notifications of the pieces of control information may be respectively performed. Pieces of control information may be provided, but the terminal device 1 may be notified of the pieces of control information at once.

The base station apparatus 3 performs a notification of scheduling information for the cell of the licensed band and scheduling information for the cell of the unlicensed band, with being included in control information. A cell used when the notification is performed is the cell 5 which is the cell of the licensed band (in FIG. 18, an arrow 153). The terminal device 1 receives the control information, extracts scheduling information, and performs configuring of a transmission and reception operation of each cell or each frequency band, in accordance with the extracted scheduling information (in FIG. 18, 154).

In FIG. 18, the cell 5 is used when each of the above-described notifying method for scheduling for the cell. However, the cell may be the cell 7. For example, in a case where the cell 5 is used as a primary cell (the cell 7 is used as a secondary cell), the primary cell may be used when the first scheduling information notifying method and the third scheduling information notifying method may be performed. In addition, the cell 7 which is the secondary cell may be changed to the cell 5, and then the cell 5 may be used. The cell 7 may be used along with the cell 5.

For example, a one specific cell may be used as a cell used for reducing processing of the terminal device 1, particularly, for reducing processing relating to blind decoding which is performed by the terminal device 1. Particularly, since the blind decoding of a primary cell is necessarily performed, a constitution using only the primary cell may have the most efficiency. Since only the scheduling information is not provided as the control information, in a case where using the primary cell is not appropriate, for example, in a case where many pieces of control information of which notifications are performed are provided, using a secondary cell is defined so as to be one desirable embodiment.

For example, it may be assumed that a notification of the scheduling information for the cell of the unlicensed band is performed in only the secondary cell. Regarding the notification of the scheduling information, in order to obtain flexibility, it is most desirable that a plurality of cells is selectively or is used together for the notification of the scheduling information. Specifically, the base station apparatus 3 can determine a cell to be used, for example, considering the volume of control information of which a notification is required to be performed, or properties of another piece of control information other than scheduling information. The other piece of control information indicates, for example, whether or not a notification thereof can be performed simultaneously to the notification of the scheduling information. In addition, the determination may be performed based on communication quality of each cell or transmitted power used for each cell.

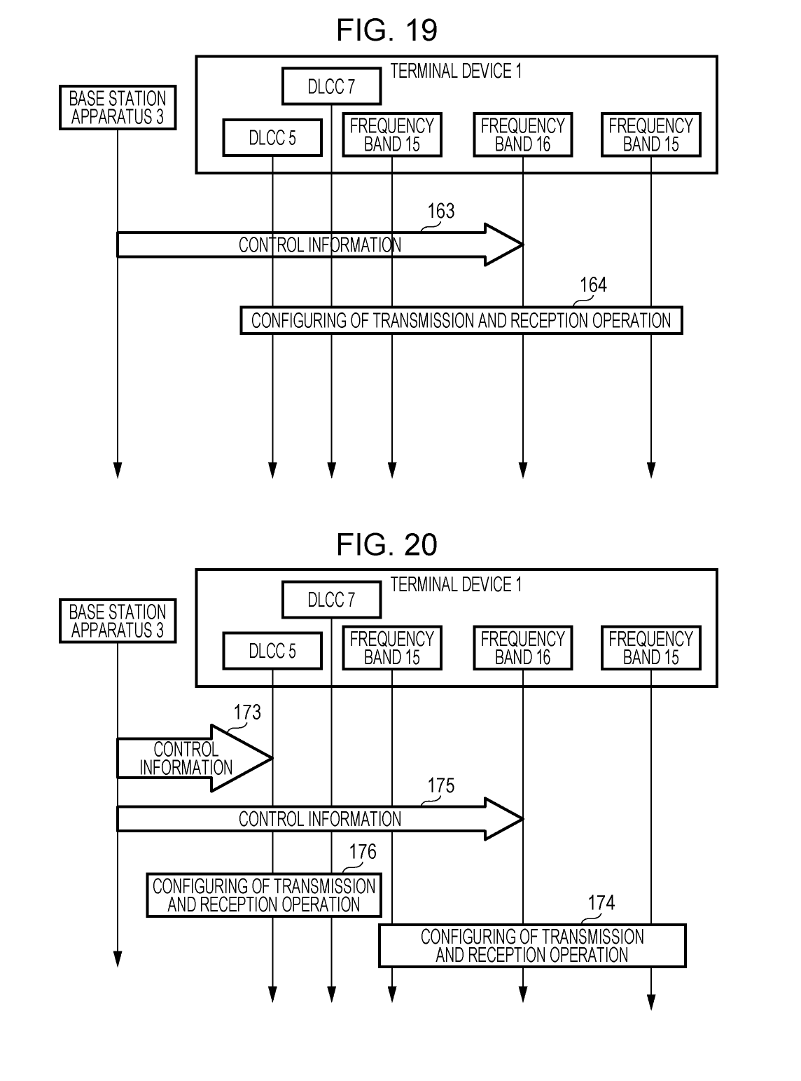

FIG. 19 illustrates still another example. FIG. 19 illustrates a case where the fourth scheduling information notifying method is performed simultaneously with the second scheduling information notifying method. Here, control information of the licensed band, which includes scheduling information assigned to the cell of the licensed band, and unlicensed-band control information which includes scheduling information assigned to the cell of the unlicensed band are included in one piece of control information, and the base station apparatus 3 notifies the terminal device 1 of the one piece of control information.

The base station apparatus 3 performs a notification of scheduling information for the cell of the licensed band and scheduling information for the cell of the unlicensed band, with being included in control information. A cell used when the notification is performed is the frequency band 16 which is used as the cell of the unlicensed band (in FIG. 19, an arrow 163).

The terminal device 1 receives the control information, extracts scheduling information, and performs configuring of a transmission and reception operation of each cell or each frequency band, in accordance with the extracted scheduling information (in FIG. 19, 164). In FIG. 19, the frequency band 16 is used as the cell of the unlicensed band, when each of the above-described notifying method for scheduling for the cell. However, the frequency band may be the frequency band 15, or the frequency band 17. In addition, other frequency bands may be used together, and all of the frequency bands may be used.

In other words, when the notification of the scheduling information is performed by using the cell of the unlicensed band, the cell of at least one of the unlicensed bands can be used. Further, when the notification of the second scheduling information or the fourth scheduling information is performed, the cell of at least one of the unlicensed bands can be used. For example, a constitution in which the frequency band 15 is used in the second scheduling information notifying method, and the frequency band 16 is used in the fourth scheduling information notifying method may be made.

Regarding an appropriate use for the frequency bands, for example, a one specific frequency band may be used as a frequency band used for reducing processing of the terminal device 1, particularly, for reducing processing relating to blind decoding which is performed by the terminal device 1. For example, the notification of the scheduling information may be performed in only the frequency band 16. It is most desirable that a plurality of frequency bands is selectively used or is used together in the notification of the scheduling information, in order to obtain flexibility for the notification of the scheduling information.

The base station apparatus 3 can determine a frequency band to be used, for example, considering the volume of control information of which a notification is required to be performed, or properties of another piece of control information other than scheduling information. The other piece of control information indicates, for example, whether or not a notification thereof can be performed simultaneously to the notification of the scheduling information. In addition, the determination may be performed based on communication quality of each cell or transmitted power used for each cell. That is, the frequency band 16 is used in FIG. 19. However, in a case where the communication quality of the frequency band 16 is deteriorated, a constitution to enable using of the frequency band 15 or 17 instead when the notification of the scheduling information is most desirable for maintain and ensuring a stable communication.

FIG. 20 illustrates still another example. FIG. 20 illustrates a case where the first scheduling information notifying method and the third scheduling information notifying method are separately performed. Here, the control information of the licensed band, which includes the scheduling information assigned to the cell of the licensed band, and the unlicensed-band control information which includes the scheduling information assigned to the cell of the unlicensed band are respectively included in pieces of control information which are different from each other, and the base station apparatus 3 separately notifies the terminal device 1 of the pieces of control information.

The base station apparatus 3 performs a notification of scheduling information for the cell of the licensed band, with being included in control information (in FIG. 20, arrow 173). The base station apparatus 3 performs a notification of scheduling information for the cell of the unlicensed band, with being included in control information (in FIG. 20, arrow 175). The terminal device 1 receives the control information, extracts scheduling information, and performs configuring of a transmission and reception operation of using the cell of the licensed band, in accordance with the extracted scheduling information (in FIG. 20, 176). The terminal device 1 extracts scheduling information regarding the cell of the unlicensed band, from the received control information, and performs configuring of a transmission and reception operation of using a frequency band which is used as the cell of the unlicensed band, in accordance with the extracted scheduling information (in FIG. 20, 174).

In FIG. 20, the cell 5 is used when each of the above-described notifying method for scheduling for the cell. However, similarly to the descriptions for FIG. 19, the cell of the licensed band to be used may be limited to a specific cell, or the cell to be used may be appropriately determined.

The frequency band 16 is used as the cell of the unlicensed band which is used in the notification of the scheduling information. However, similarly to the descriptions for FIG. 20, the cell of the licensed band to be used may be limited to a specific cell. In addition, the specific cell and a plurality of other cells may be appropriately used.

Here, the first scheduling information notifying method to the fourth scheduling information notifying method are described. It is desirable that all of the first scheduling information notifying method to the fourth scheduling information notifying method are defined to be usable. However, it is not limited thereto, and for example, a control as follows may be performed, or a constitution as follows may be made. For example, a constitution as follows may be made. That is, regarding the notifying method for the scheduling information for the cell of the licensed band, the first scheduling information notifying method is defined to be usable. Regarding a frequency band which is used as the cell of the unlicensed band, the third scheduling information notifying method or the fourth scheduling information notifying method is selectively used or both thereof are used. This constitution is effective, for example, in a case where the fifth example is performed, particularly, the terminal device 1 independently starts the second communication, and the base station apparatus 3 starts a communication with the terminal device 1 by using the cell of the unlicensed band in a state where the base station apparatus 3 does not recognize that the terminal device 1 has started the second communication.

A case where the base station apparatus 3 starts a communication by using the frequency band 15 in a case where the terminal device 1 starts the second communication with another device (for example, printer) by using, for example, the frequency band 15 is considered. In a case where the base station apparatus 3 performs the second scheduling information notifying method by using the frequency band 15, the base station apparatus 3 notifies the terminal device 1 of the control information which includes the scheduling information for the licensed band, by using the frequency band 15.

However, the terminal device 1 is in the process of communicating with another device by using the frequency band 15, and thus reception of the control information of which the notification from the base station apparatus 3 has been performed is not possible. If the reception of the control information is not possible, acquiring scheduling information or another piece of control information which is required for the cell of the licensed band is also possible. In the worst case, acquiring the scheduling information for the cell of the licensed band is not possible or acquiring the control information of the licensed band is not possible. In addition, the terminal device 1 may be in a state where a control of the cell of the licensed band is not possible, and using the licensed band is not possible. Here, as the state where the control of cell is not possible, and using the licensed band is not possible, for example, a state where a communication is disconnected, a state where a problem occurs in the communication, a state of RadioLinkFailure, a state where maintaining or ensuring a stable communication is not possible, and the like are provided.

Similarly, similarly to in a case where a notification of the control information for the cell of the unlicensed band is performed by using the cell of the unlicensed band, a case where reception of the control information is not possible may occur. Thus, the notification of the control information of the licensed band is not performed in the cell of the unlicensed band. In other words, thus, the notification of the control information of the licensed band by using only the cell of the licensed band in the cell of the licensed band is desirable for ensuring a stable communication. It is possible to prevent disconnection of a communication between the base station apparatus 3 and the terminal device 1, and to maintain the stable communication.

Such a constitution is not limited to the case where the fifth example is performed. For example, the unlicensed band has an advantage of being freely usable by users of unspecified individuals, according to the properties thereof. However, as the side effect thereof, an immoral use, an use of an incomplete device, and a use of a device, which ignores the specification thereof is performed, and thus a probability of the communication being not stable is higher than that in a case of the licensed band. Thus, the base station apparatus 3 may not notify the terminal device 1 of control information by using the cell of the unlicensed band. The control information corresponds to information important to cause a probability of disconnecting a communication between the terminal device 1 and the base station, or a probability of the communication being influenced.

Particularly, the terminal device 1 may be notified of the control information used in the cell of the licensed band, by using the cell of the licensed band. The control information of the cell of the unlicensed band may use the cell of the unlicensed band. As described above, even in a case where a problem occurs in the communication of the unlicensed band and reception of the control information of the unlicensed band by the terminal device 1 is not possible, in the worst case, the communication of the unlicensed band is just disconnected, and the communication between the base station apparatus 3 and the terminal device 1 is not disconnected. Thus, the above case is not a big problem. In a case where the communication of the unlicensed band frequently becomes unstable, even in a case of the control information of the unlicensed band, a notification of the control information may be performed by using the licensed band. In a case where a safe use of the unlicensed band is ensured by a communication environment (for example, a case where it is recognized that a problem in the communication occurs significantly frequently in the unlicensed band), the notification of the control information may be performed by using the fourth scheduling information notifying method.

Using a combination of the first to fourth scheduling information notifying methods is desirable because of enabling a more flexible mechanism to be provided for the notification of the scheduling information. A constitution in which the base station apparatus 3 determines whether or not a communication problem occurs in a communication using the unlicensed band, and appropriately uses the first to the fourth scheduling information notifying methods is more desirable. Conversely, from a viewpoint of cost, for example, a case where means for determining whether or not a communication problem occurs in a communication using the unlicensed band is not provided, or the determination is not performed, a constitution of using only the first scheduling information notifying method and the third scheduling information notifying method may be made, or a constitution defined to be a constitution of using the first scheduling information notifying method, the third scheduling information notifying method, and the fourth scheduling information notifying method may be made.

In the above-described embodiment, a portion of the terminal device 1 and the base station apparatus 3 may be realized in a computer. In this case, the realization may be performed in such a manner that a program for realizing the control function is recorded in a computer readable recording medium, and the program recorded in this recording medium is read in a computer system, and the read program is executed. The “computer system” referred herein is defined to be a computer system which is mounted in the terminal device 1 or the base station apparatus 3, and to include an OS or hardware of peripheral devices and the like.

The “computer readable recording medium” refers to a portable medium such as a flexible disk, a magneto-optic disc, a ROM, and a CD-ROM, and a storage device such as a hard disk, which is mounted in a computer system. The “computer readable recording medium” may include a medium which dynamically holds a program for a short time, such as a communication line in a case where the program is transmitted via a network such as the Internet or a communication circuit line such as a telecommunication circuit line. The “computer readable recording medium” may include a medium which holds a program for a constant period, such as a volatile memory in a computer system which functions as a server or a client in the above case. The program may be provided for realizing some of the above-described functions, and the above-described functions may be realized by a combination with a program obtained by recording all of the above-described functions in the computer system.

In the above-described embodiment, a portion or the entirety of the terminal device 1 and the base station apparatus 3 may be realized by LSI which is a typical integrated circuit. Each of the function blocks of the terminal device 1 and the base station apparatus 3 may be realized as a chip. Some or all of the function blocks may be integrated so as to be realized as a chip. A method of forming an integrated circuit is not limited to the LSI, and the function blocks may be realized by dedicated circuits or a general-purpose processor. In a case where the progress of the semiconductor technology causes a technology of forming an integrated circuit which replaces the LSI to be emerged, an integrated circuit obtained by using the emerged technology can be used.

Hitherto, one embodiment of the present invention has been described in detail, with reference to the drawings. However, the specific configuration is not limited to the above descriptions, and various design changes may be made in a range without departing from the gist of the invention.

This international application is based upon and claims the benefit of priority of the prior Japanese Patent Application No. 2014-089956, filed on Apr. 24, 2014; the entire contents of which are incorporated herein by reference.

### REFERENCE SIGNS LIST

1(1A, 1B, 1C) MOBILE STATION APPARATUS
3 BASE STATION APPARATUS
5 CELL
7 CELL
11 ACCESS POINT
15 FREQUENCY BAND
16 FREQUENCY BAND
17 FREQUENCY BAND
101 HIGHER LAYER PROCESSING CIRCUIT UNIT
103 CONTROL CIRCUIT UNIT
105 RECEPTION CIRCUIT UNIT
107 TRANSMISSION CIRCUIT UNIT
109 TRANSMIT AND RECEIVE ANTENNA
301 HIGHER LAYER PROCESSING CIRCUIT UNIT
303 CONTROL CIRCUIT UNIT
305 RECEPTION CIRCUIT UNIT
307 TRANSMISSION CIRCUIT UNIT
309 TRANSMIT AND RECEIVE ANTENNA
1011 RADIO RESOURCE CONTROL CIRCUIT PORTION
1051 DECODING CIRCUIT PORTION
1053 DEMODULATION CIRCUIT PORTION
1055 DEMULTIPLEXING CIRCUIT PORTION
1057 RADIO RECEPTION CIRCUIT PORTION
1071 CODING CIRCUIT PORTION
1073 MODULATION CIRCUIT PORTION
1075 MULTIPLEXING CIRCUIT PORTION
1077 RADIO TRANSMISSION CIRCUIT PORTION
3011 RADIO RESOURCE CONTROL CIRCUIT PORTION
3051 DECODING CIRCUIT PORTION
3053 DEMODULATION CIRCUIT PORTION
3055 DEMULTIPLEXING CIRCUIT PORTION
3057 RADIO RECEPTION CIRCUIT PORTION
3071 CODING CIRCUIT PORTION
3073 MODULATION CIRCUIT PORTION
3075 MULTIPLEXING CIRCUIT PORTION
3077 RADIO TRANSMISSION CIRCUIT PORTION

1.-12. (canceled)

13. A terminal device that communicates with a base station apparatus, comprising:
a reception unit that receives data from the base station apparatus by applying a first communication scheme with carrier aggregation using a licensed band and an unlicensed band; and
a transmission unit that transmits data to the base station apparatus by applying the first communication scheme with the carrier aggregation, or transmits data to an apparatus other than the base station apparatus by applying a second communication scheme in the unlicensed band,
wherein the reception unit receives information for prohibiting the second communication scheme from the base station apparatus.

14. The terminal device according to claim 13,
wherein the transmission unit transmits data to the apparatus other than the base station apparatus by applying the second communication scheme in the unlicensed band in a case where the information for prohibiting the second communication scheme is not received.

15. The terminal device according to claim 13,
wherein the transmission unit transmits data to the base station apparatus by applying the first communication scheme in the unlicensed band in a case where the information for prohibiting the second communication scheme is received.

16. The terminal device apparatus according to claim 13,
wherein the information for prohibiting the second communication scheme is indicated by at least a piece of control information regarding an amount of assigned resource, a modulation scheme and a transmitted power.

17. A base station apparatus that communicates with a terminal device, comprising:
a reception unit that receives data from the terminal device by applying a first communication scheme with carrier aggregation using a licensed band and an unlicensed band, or receives data from the terminal device by applying a second communication scheme in the unlicensed band; and
a transmission unit that transmits data to the base station apparatus by applying the first communication scheme with the carrier aggregation,
wherein the transmission unit transmits information for prohibiting the second communication scheme to the terminal device.

18. The base station apparatus according to claim 17,
wherein the reception unit receives data from the terminal device by applying the second communication scheme in the unlicensed band in a case where the information for prohibiting the second communication scheme is not received.

19. The base station apparatus according to claim 17,
wherein the information for prohibiting the second communication scheme is indicated by at least a piece of control information regarding an amount of assigned resource, a modulation scheme and a transmitted power.
